(19) United States
(12) Patent Application Publication
(10) Pub. No.: US 2004/0227964 A1
(43) Pub. Date: Nov. 18, 2004

(54) Memory color adjustment of image

(76) Inventor: Makoto Fujino, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/741,159

(22) Filed: Dec. 18, 2003

(30) Foreign Application Priority Data
Dec. 18, 2002 (JP) 2002-366505
Nov. 27, 2003 (JP) 2003-396638

(51) Int. Cl. H04N 1/62; H04N 1/50

(52) U.S. Cl. 358/1.9; 358/504; 358/527; 358/531

(57) ABSTRACT

An output device for outputting an image using image data is disclosed. This output device comprises an image quality adjustment unit for adjusting the color of an area within the image data the color of which is close to a preset memory color such that this color comes closer to a preset target color, a target color setting unit for allowing the user to set the target color, and an image output unit for outputting an image in accordance with the color-adjusted image data. A certain image quality adjustment condition can be determined using evaluation results for each of multiple image groups that contain mutually different images and respectively include at least one image from among multiple natural images used for evaluation that each have a different certain image quality.

### BACKGROUND OF THE INVENTION

1. Field of the Invention

The present invention relates to an image quality adjustment technology that adjusts the image quality of image data.

2. Description of the Prior Art

The image quality of image data generated by a digital still camera (DSC), digital video camera (DVC) or the like can be freely adjusted using an image retouching application program on a personal computer or similar equipment. Image retouching application program generally includes an image adjustment function that automatically adjusts the image quality of the image data, and the image quality of the images output from the output device can be improved by using this image adjustment function. Known examples of this type of image output device include a CRT, an LCD, a printer, a projector, a television receiver and the like.

In addition, a function to automatically adjust image quality may also be included in a printer driver that controls the operation of the printer constituting one type of output device, and the image quality of printed images can also be improved by using such a printer driver.

One important element in determining the image quality of image data is color. If the image colors are reproduced using colors that the user finds appealing, the user will recognize the images as having good image quality. In particular, if the areas that are easily noticed by the user are reproduced in colors that the user finds appealing, the images can be deemed high-quality images. Such easily-noticed areas include skin color areas of people in a portrait image, blue areas of the sky in a scenery image, or green areas in an image of mountains (the colors of these easily-noticed areas are termed ‘memory colors’ below). If these colors of these areas are reproduced in a manner appealing to the user, the user recognizes the image as being of high quality. Consequently, a method is employed whereby the image quality is improved by adjusting the colors of areas the colors of which are similar to the memory colors in the image data to make them more closely resemble colors deemed appealing to the user (i.e., the target colors). (See, for example, JP2001-169135A, and JP2002-252779A.)

The image quality adjustment function provided via the image retouching application program or printer driver described above adjusts image quality based on image data having general image quality characteristics. In particular, adjustment of the colors of areas the colors of which are similar to the memory colors is performed using predetermined general target colors. However, colors deemed appealing by the user often differ from user to user. Furthermore, because image data to undergo image processing can be generated under various conditions, an ‘appealing’ color can vary depending on the image.

As a result, it can occur that sufficient image quality improvement is not obtained through image quality adjustment using general target colors. This problem arises not only in regard to images generated using a DSC, but also in regard to images generated by a different image generating device, such as a DVC.

On the other hand, image quality is sometimes adjusted in accordance with user-prescribed parameters instead of automatically. In this case, determination of the proper parameter is sometimes difficult, leading to insufficient improvements in image quality. This problem is not limited to adjustment of the colors of areas [the colors of which are] similar to the memory colors, but in connection with other types of image quality adjustment, such as lightness adjustment or sharpness adjustment. Furthermore, the issue arises not only in regard to images generated by a DSC, but also in regard to images generated by a different image generating device, such as a DVC.

### SUMMARY OF THE INVENTION

A first object of the present invention is to provide a method for proper adjustment of image quality in accordance with the user's preference. A second object is to provide a technology by which to easily determine the parameters for image quality adjustment.

The output device pertaining to a first aspect of the invention is an output device that outputs an image using image data. The output device includes an image quality adjuster for adjusting color of an area within the image data that is close to a preset memory color such that the color comes closer to a preset target color; a target color setter for allowing a user to set the target color, and an image output unit for outputting an image in accordance with the color-adjusted image data.

According to this output device, because adjustment of the image quality of areas the color of which is similar to the memory color can be performed using a user-specified target color, image quality can be properly adjusted in accordance with the user's preference.

The method for setting image quality adjustment parameters in accordance with a second aspect of the present invention is a method for setting image quality adjustment parameters used to adjust the image quality of target images. The method includes the steps of: (a) outputting multiple image groups that contain mutually differing images and-respectively include at least one image from among multiple natural images used for evaluation that each have a certain different image quality; (b) receiving multiple results of evaluation determined by the user for each of the multiple image groups; and (c) determining the image quality adjustment parameters for the certain image quality using the multiple evaluation results.

According to this method, because image quality parameters are determined using multiple image evaluation results, the parameters for adjusting image quality can be easily set. Furthermore, because the images used for evaluation are natural images, image quality adjustment parameters suitable for natural images can be adopted.

This invention can be implemented in various forms, such as an image output method or device, an image data processing method or device, an image quality adjustment parameter determination method or device, a computer program that implements the functions of such method or device, a recording medium on which such computer program is recorded, and data signals that are included in this program and embodied in a carrier wave.

The above and other objects, features, aspects and advantages of the present invention will be made clear from the description of the preferred embodiments provided below together with the drawings.

### BRIEF DESCRIPTION OF THE DRAWINGS

FIG. 1 is a block diagram showing the construction of an image output system.

FIG. 2 is a basic construction diagram of a printer 20.

FIG. 3 is a block diagram showing the construction of the printer 20.

FIG. 4 is a block diagram showing the basic components of an image quality adjustment routine.

FIG. 5 is a flow chart showing the sequence of operations for the image quality adjustment routine.

FIGS. 6(a)-6(c) are explanatory drawings to explain a memory color area.

FIGS. 7(a) and 7(b) are explanatory drawings regarding the color difference index and gradation value adjustment routine.

FIG. 8 is a flow chart showing the sequence of operations for a target color setting routine.

FIG. 9 is an explanatory drawing showing target color setting.

FIG. 10 is an explanatory drawing showing an example of a test pattern.

FIG. 11 is a flow chart showing the sequence of operations for a second embodiment of the target color setting routine.

FIG. 12 is an explanatory drawing showing an example of a configuration screen for the second embodiment of the target color setting routine.

FIG. 13 is an explanatory drawing showing examples of test patterns used in the second embodiment of the target color setting routine.

FIG. 14 is an explanatory drawing showing an example of scores.

FIG. 15 is an explanatory drawing showing an example of a configuration screen for a third embodiment of the target color setting routine.

FIG. 16 is an explanatory drawing showing examples of test patterns used in the third embodiment of the target color setting routine.

FIGS. 17(a) and 17(b) are explanatory drawings showing the basic components of a second embodiment of the image quality adjustment routine (color balance adjustment routine).

FIG. 18 is a block diagram showing the construction of an image data processing program 200a of the second embodiment.

FIG. 19 is a flow chart showing the sequence of operations for a routine to set a target color and score in the second embodiment.

FIG. 20 is a flow chart showing the sequence of operations for the image quality adjustment routine (color balance adjustment routine).

FIGS. 21(a) and 21(b) are explanatory drawings showing the calculation of a score for the representative color of a memory color area.

FIGS. 22(a) - 22(d) are graphs regarding the adjustment amount used in the image quality adjustment routine.

FIGS. 23(a) and 23(b) are explanatory drawings showing a change in the representative color of a memory color area.

FIGS. 24(a) and 24(b) are explanatory drawings showing the basic components of the second embodiment of the point usage image quality adjustment routine.

### DESCRIPTION OF THE PREFERRED EMBODIMENTS

Embodiments of the present invention will be described below according to the following sequence based on the following examples:

A. Device construction

B. First embodiment

C. Second embodiment

D. Variations

A. Device Construction:

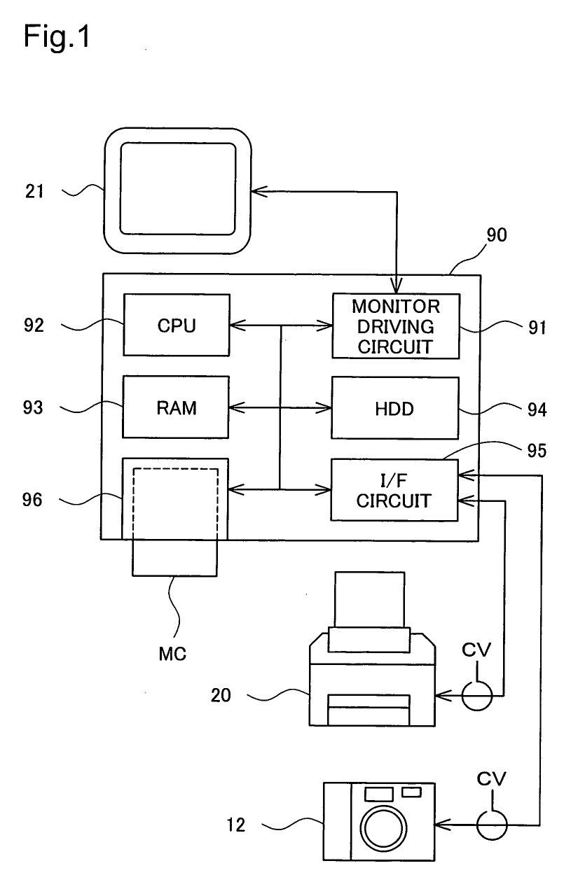

FIG. 1 is a block diagram showing the construction of an image output system constituting an embodiment of the present invention. This image output system includes a printer 20 that serves as an image output device for outputting images, and a computer 90 that serves as an image data processing device. The computer 90 is a type of computer in general use, and executes the image quality adjustment routine described below. In addition to the printer 20, a monitor 21, such as a CRT display, an LCD display or a projector, may be used as an image output device. In the description below, the printer 20 will be deemed the image output device. In addition, the computer 90 serving as the image data processing device and the printer 20 serving as the image output device may also be collectively referred to in a broad sense as an ‘output device.’

The computer 90 includes a CPU 92 that executes the image quality adjustment routine described below, a RAM 93 that temporarily stores the results of processing performed by the CPU 2, image data and the like, and a hard disk drive (HDD) 94 that stores a program that executes the image quality adjustment routine, data needed for the execution of such routine, and the like. The computer 90 also includes a memory card slot 96 that receives data from a memory card MC inserted therein, a monitor drive circuit 91 that drives the monitor 21, and an I/F circuit 95 that serves as an interface to the printer 20 or to a digital still camera 12 that functions as an image generating device. The I/F circuit 95 has a built-in interface circuit designed for ease of connection to the printer 20 or the digital still camera 12. This interface circuit may constitute a parallel interface circuit or a Universal Serial Bus interface circuit, for example.

The computer 90 can obtain, over a cable CV, for example, image data generated by the digital still camera 12 serving as an image generating device. The computer 90 can also have a construction wherein image data is stored in the memory card MC by the image generating device and the computer 90 obtains this image data via the memory card MC. A construction may also be adopted wherein image data is obtained over a network (not shown).

When an image data processing program such as an image retouching application or a printer driver is started up via user operation, the CPU 92 executes the image quality adjustment routine that adjusts the color of the image data. A construction may also be adopted wherein the image data processing program is booted automatically upon detection of insertion of the memory card MC into the memory card slot 96 or connection of the digital still camera 12 to the I/F circuit 95 via a cable. The specific image data processing executed by the CPU 92 will be described below.

The image data that is quality-adjusted by the CPU 92 is output to an image output device such as the printer 20, and is then output by the receiving image output device.

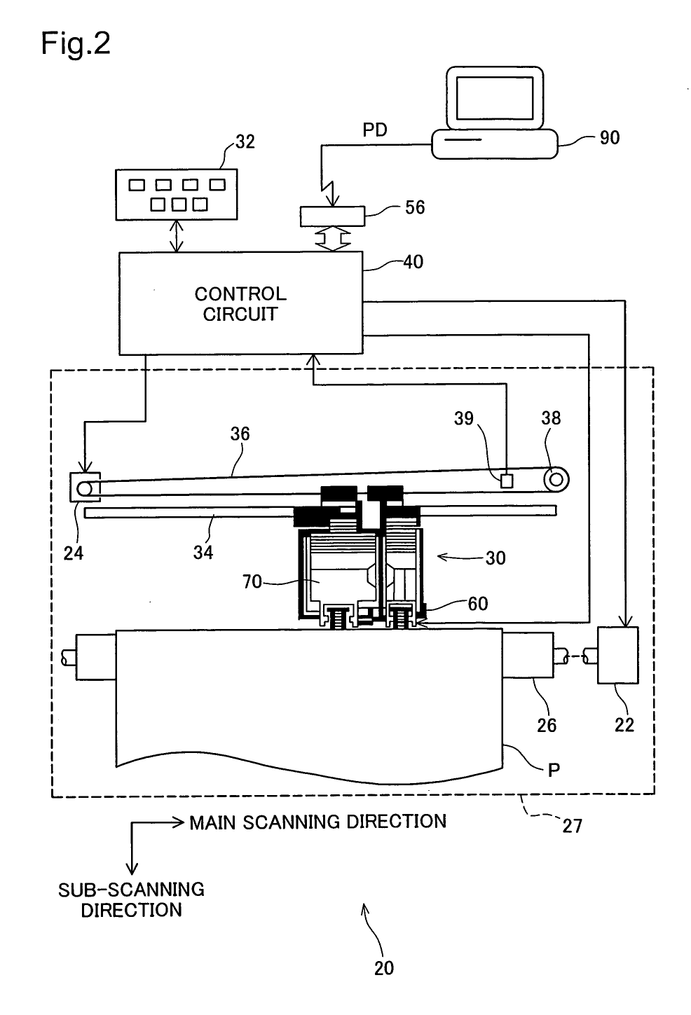

FIG. 2 is a drawing showing the basic construction of the printer 20. The printer 20 is a printer that can output images, and in this embodiment constitutes an inkjet printer that forms dot patterns by expelling onto a printing medium ink of the four colors of cyan (C), magenta (Mg), yellow (Y) and black (K). Alternatively, an electrophotographic printer that forms images by transferring and fusing toner onto a printing medium may be used. In addition to the four colors of ink described above, the colors of light cyan (LC) having a lower concentration than cyan (C), light magenta (LM) having a lower concentration than magenta (Mg) and dark yellow (DY) having a higher concentration than yellow (Y) may be used. Alternatively, where a monochrome printer is used, black (K) ink only may be used, or red (R) or green (G) ink may be used. The types of ink or toner used may be determined in accordance with the characteristics of the images to be output.

The printer 20 includes an image output unit 27 that executes printing, an operation panel 32 and a control circuit 40 that controls the flow of signals between the operation panel 32 and the image output unit 27, as shown in FIG. 2. The image output unit 27 has a sub-scanning feeding mechanism that conveys printing paper P in the sub-scanning direction using the paper feed motor 22, a main scanning conveyance mechanism that moves the carriage 30 forward and backward along the axis of the platen 26 (the main scanning direction) using the carriage motor 24, and a head driving mechanism that executes control in order to drive the print head unit 60 mounted to the carriage 30 to expel ink and form dots. The print head unit 60 includes a print head (not shown) that has nozzles capable of expelling the appropriate ink. The control circuit 40 is connected to the computer 90 via a connector 56.

The sub-scanning feeding mechanism that conveys the printing paper P includes a gear train (not shown) that transmits the rotation of the paper feed motor 22 to the platen 26 and the paper feed rollers (also not shown). The main scanning conveyance mechanism that moves the carriage 30 forward and backward includes a slide shaft 34 that is disposed parallel to the axis of the platen 26 and slidably support the carriage 30, a pulley 38 that suspends via tension an endless drive belt 36 between itself and the carriage motor 24, and a position sensor 39 that detects the original position of the carriage 30.

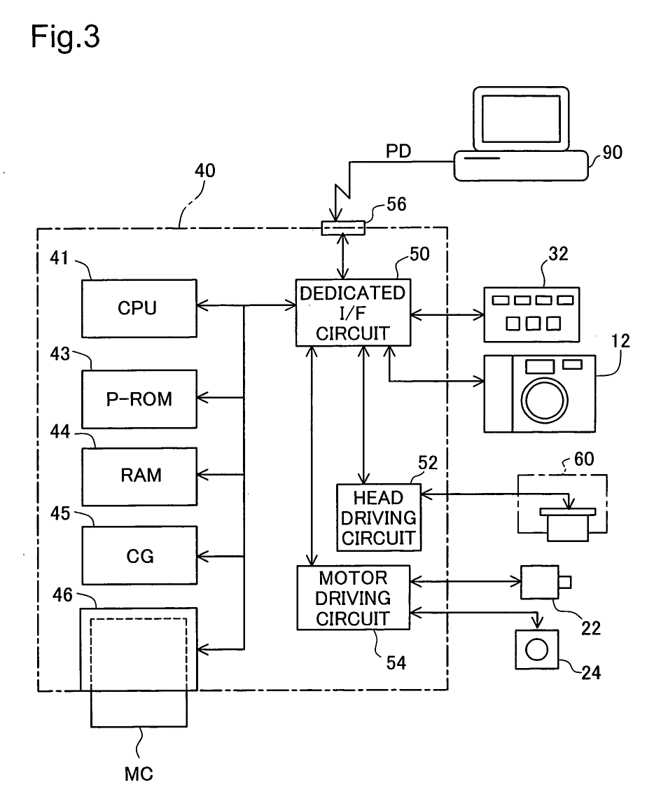

FIG. 3 is a block diagram that shows the construction of the printer 20. The control circuit 40 constitutes an arithmetic-logic circuit that includes a CPU 41, a programmable ROM (PROM) 43, a RAM 44 and a character generator (CG) 45 in which a character dot matrix is stored. This control circuit 40 further includes a memory card slot 46 that receives data from the memory card MC, a dedicated I/F circuit 50 that serves exclusively as an interface to external motors and the like, a head drive circuit 52 that is connected to this dedicated I/F circuit 50 and drives the print head unit 60 to expel ink, and a motor drive circuit 54 that drives the paper feed motor 22 and the carriage motor 24. The dedicated I/F circuit 50 incorporates a parallel interface circuit, and can receive print data PD that is supplied from the computer 90 via the connector 56. The circuit built into the dedicated I/F circuit 50 is not limited to a parallel interface circuit, however, and such circuit may be a Universal Serial Bus interface circuit or other circuit determined in consideration of the ease with which it connects to the computer 90. The printer 20 executes printing based on the print data PD. The RAM 44 functions as a buffer memory for temporary storage of raster data.

The printer 20 having the hardware construction described above feeds the printing paper P via the paper feed motor 22, and drives the carriage 30 forward and backward via the carriage motor P while simultaneously drives the print head to expel ink droplets to form images on the printing paper P based on the print data PD by forming ink dots thereon.

B. First Embodiment:

B1. First Embodiment of Image Quality Adjustment Routine:

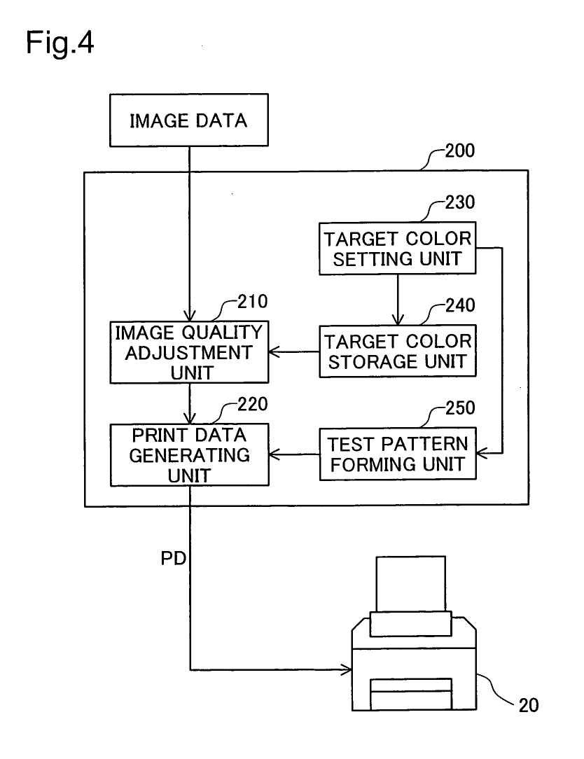

FIG. 4 is a block diagram showing the basic components of an image quality adjustment routine. In the computer 90, an image data processing program 200 is operated under a prescribed operating system. The image data processing program 200 that receives instructions from the user to print the image data converts the image data into print data to be supplied to the printer 20 after adjusting the image quality thereof. In the example shown in FIG. 4, the image data processing program 200 includes an image quality adjustment unit 210, a print data generating unit 220, a target color setting unit 230, a target color storage unit 240 and a test pattern forming unit 250.

The image quality adjustment unit 210 executes the image quality adjustment routine (color balance adjustment routine) with respect to the image data using a target color stored in the target color storage unit. The image quality adjustment routine will be described in detail below.

The print data generating unit 220 converts the image data that was quality-adjusted by the image quality adjustment unit 210 into multi-value gradation data representing the amounts of the multiple colors of ink that can be used by the printer 20. It also performs so-called halftone processing of the obtained ink amount data, arranges the obtained halftone data in the order of data to be forwarded to the printer 20, and outputs the final print data PD to the printer 20. The printer 20 prints images using the received print data PD. The print data PD includes raster data that indicates the state of dot recording during each main scanning pass and data indicating the sub-scan feed amount.

The target color storage unit 240 can store a target color used by the image quality adjustment unit 210. The user can set the target color to be stored by the target color storage unit 240 via the target color setting unit 230. The details of this operation will be described in detail below.

The test pattern forming unit 250 can prepare a test pattern that can be used for setting a target color. The prepared test pattern is converted into print data PD by the print data generating unit 220 and is then sent to the printer 20 and printed. The test pattern will be described in detail below.

The image data processing program 200 corresponds to a program that implements a function to adjust the image quality of image data. The image data processing program 200 is supplied in the form of a program recorded on a computer-readable recording medium. Various types of computer-readable recording media may be used, such as a flexible disk, CD-ROM, magneto-optical disk, ID card, ROM cartridge, punch card, printed matter on which symbols such as a bar code are printed, a computer's internal storage device (such as RAM or ROM), or an external storage device.

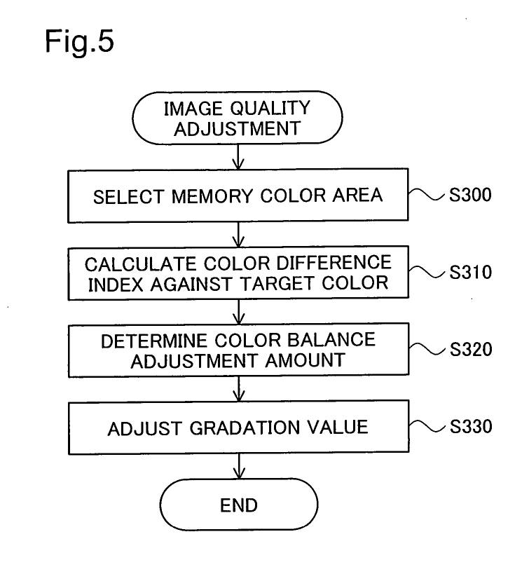

FIG. 5 is a flow chart showing the sequence of operations for the image quality adjustment routine executed by the image data processing program 200 described above. In step S300, the CPU 92 (see FIG. 1) selects an area having a color close to the memory color (hereinafter referred to as a ‘memory color area’) used for calculating the image data coloring (this step is described in detail below). Next, in step S310, the difference in color between the memory color area and the target color (also termed the ‘color difference index’) is calculated using the pixel values of the memory color area selected in step S300. The target color constitutes data regarding a color deemed appealing to the user, and is stored by the target color storage unit 240 (see FIG. 4). The difference between the average of the gradation values of the memory color area and the gradation value of the target color may be used as the color difference index. In step S320, the amount of color balance adjustment is set based on the color difference index, and in step S330, color balance adjustment is performed such that the color of the memory color area approaches the target color (this processing is described in detail below).

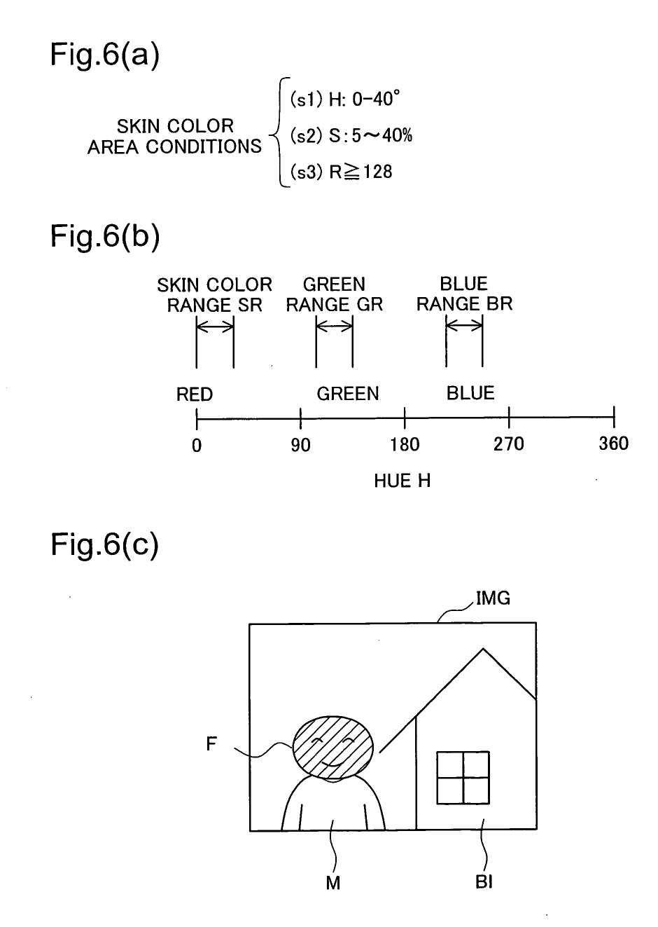

FIGS. 6(a)-6(c) are explanatory drawings to explain the memory color area selected in step S300 (see FIG. 5). FIGS. 6(a)-6(c) pertain to an example in which the color of human skin is used as the memory color. FIG. 6(a) is an explanatory drawing that shows the conditions for selecting an area the color of which is close to the color of human skin as the memory color area. In this embodiment, pixels that satisfy the three conditions below are selected as pixels in a memory color area.

(s1) The hue H falls within the range of 0°-40°.

(s2) The saturation S falls within the range of 5%-40%.

(s3) The gradation value of red (R) is at least 128 when the overall range of gradation values for red (R) is 0-255.

FIG. 6(b) is an explanatory drawing showing the relationship between the value of the hue H and the color. In this embodiment, the overall range of the hue H is 0°-360°, where 0° indicates red, 120° indicates green, and 240° indicates blue. Areas in which the hue H is within the range of 0°-40°, i.e., the reddish range, are used as areas within the skin color range SR.

FIG. 6(c) is an explanatory drawing showing an area composed of a color close to skin color (i.e. a skin color area) selected in accordance with the three conditions (s1)-(s3) described above. The image IMG in FIG. 6(c) is an image containing a man M and a building BL. The area satisfying the three conditions above is represented by shading using diagonal lines. In the example of FIG. 6 (c), the person's face F is represented by diagonal shading. Using the three conditions above, the area expressing a person's face (the face F in this embodiment) can be selected as a memory color area. The pixels used for the memory color area need not comprise a single contiguous area as shown in FIG. 6(c), and may be divided into a number of areas. In other words, all pixels having pixel values that satisfy the three conditions are used as pixels of a memory color area.

Where image data is expressed in a color space in which hue and saturation are not included as parameters, such as where it is expressed in an RGB color space, the hue and saturation can be obtained at each pixel position by converting the image data to a color space that includes hue and saturation as parameters, such as an HLS color space or an HIS color space.

The memory color need not be skin color, and may be set based on any easily noticeable area, such as the blue of the sky or the green of a mountain. Furthermore, the range of conditions used for selection of the memory color may be determined based on a sensory test of image output results. The selection conditions for skin color areas in particular need not be those shown in FIG. 6(a), and different settings may be used.

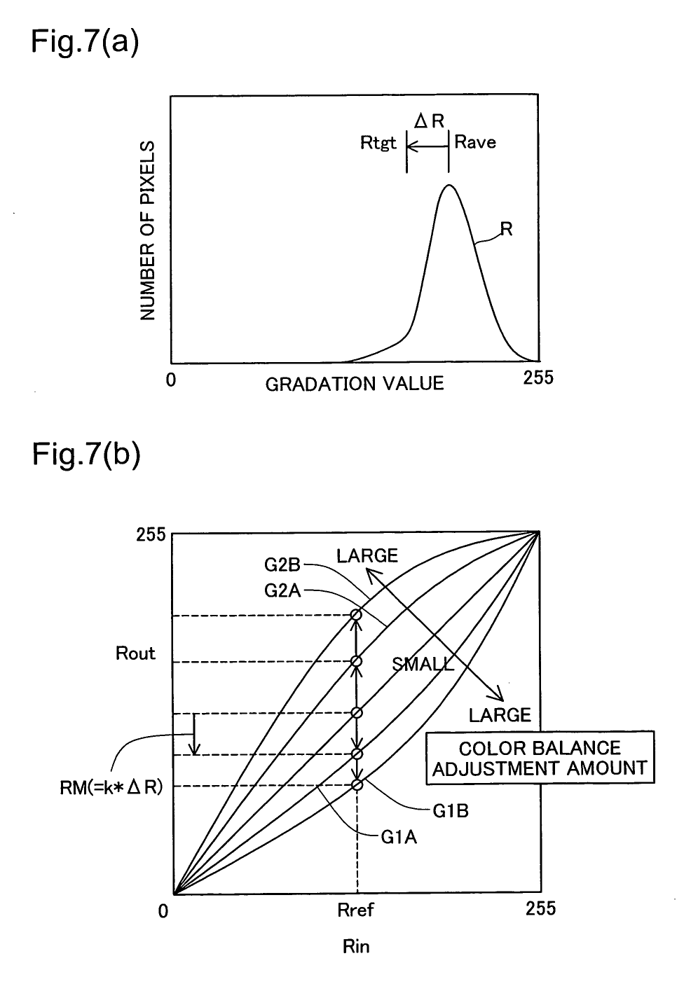

FIGS. 7(a) and 7(b) are explanatory drawings regarding the color difference index and the gradation value adjustment routine (color balance adjustment routine). FIG. 7(a) shows an example of the distribution of gradation values for the color red (R) in the memory color area selected in step S300 (see FIG. 5).

The Equations 1 shown below constitute formulae for calculating color difference indices (ΔR, ΔG, ΔB) for a target color and a memory color area.

ΔR=Rtgt-Rave

ΔG=Gtgt-Gave

ΔB=Btgt-Bave [Eq. 1]

Here, Rave, Gave and Bave are the average values for R, G and B in the memory color area, and Rtgt, Gtgt and Btgt are the R, G and B values for the target color.

In the example shown in the Equations 1, the differences between the gradation values for RGB for the target color (Rtgt, Gtgt, Btgt) and the average gradation values for R, G and B in the memory color area (Rave, Gave, Bave) are used as color difference indices (ΔR, ΔG, ΔB). Where the color of the memory color area is very close to the target color, the average gradation values for R, G and B in the memory color area (Rave, Gave, Bave) are nearly identical to the gradation values for RGB for the target color (Rgtg, Gtgt, Btgt) for each color, and therefore small values are obtained for the color difference indices (ΔR, ΔG, ΔB). Where there is a significant difference between the color of the memory color area and the target color, the values of the RGB average gradation values (Rave, Gave, Bave) for the memory color area and the RGB gradation values (Rtgt, Gtgt and Btgt) for the target color are different. In this case, a larger difference is obtained for a color component that differs from the target color to a larger degree.

FIG. 7(b) is an explanatory drawing showing the relationship between the input level Rin and the output level Rout for the red component (R) in the gradation value adjustment routine of this embodiment. In the curve G1A, the output level Rout is smaller than the input level Rin. If gradation value adjustment for red component (R) is performed using this curve G1A, the gradation value for the red component (R) can be reduced in images in which the average gradation value Rave for the red component (R) for the memory color area is larger than the gradation value Rtgt for the target color, such that the color can be made closer to the target color.

This curve G1A can be prepared by adjusting the output level Rout corresponding to the adjusted input level Rref to be smaller than the original value by an adjustment amount RM, for example. The output levels Rout corresponding to other input levels Rin are interpolated using a spline function. The adjustment amount RM is a value determined based on the color difference index ΔR for the color red (R) (see FIG. 7(a), Equation 1); the product of the color difference index ΔR and a constant (k) may be used, for example. A value determined based on the sensory test of the image output results may be used for the value of the constant (k). The relationship between the color difference index ΔR and the adjustment amount RM need not be a proportional one, and it is acceptable if the adjustment amount RM increases as the color difference index increases. A preset value may be used as the adjustment input level Rref. For example, where the overall range of the red component (R) is 0-255, a mid-range input level of 128 may be used.

The curve G1B shows the input/output relationship used during a gradation value adjustment routine where the amount of color balance adjustment is larger than that used in the curve G1A. To say that ‘the amount of color balance adjustment is large’ here means that the amount of change in the gradation value for that color component is large. Where the color difference index ΔR is large, because the adjustment amount RM calculated using a prescribed constant (k) becomes large, the amount of color balance adjustment also becomes large. Therefore, even where the color difference index ΔR is large, the color imbalance can be reduced. In this way, by virtue of a construction wherein the amount of color balance adjustment increases as the color difference index increases, the color imbalance can be appropriately reduced in accordance with the amount of color balance adjustment and the color made to approach the target color.

The curve G2A shows an input/output relationship wherein the output level Rout increases faster than the input level Rin, and is used where the color is imbalanced such that red component R is weaker than the target color. The curve G2B shows an input/output relationship that is used during the gradation value adjustment routine where the amount of color balance adjustment is larger than that used with the curve G2A. Where the color is imbalanced to the ‘weak’ side, i.e., where the average adjustment value Rave for the memory color area is smaller than the gradation value Rtgt for the target color, the adjustment amount RM, and therefore the amount of color balance adjustment, is determined based on the color difference index ΔR, as in the case where the color is imbalanced toward the ‘strong’ side.

The relationship between the input level and output level described above is established in the same manner for color components other than red. It should be noted that the gradation value adjustment is carried out for the memory color areas. In this way, the color of easily-noticed memory color areas can be adjusted to a more appealing color without changing the colors of other areas.

B2. First Embodiment of Target Color Setting Routine:

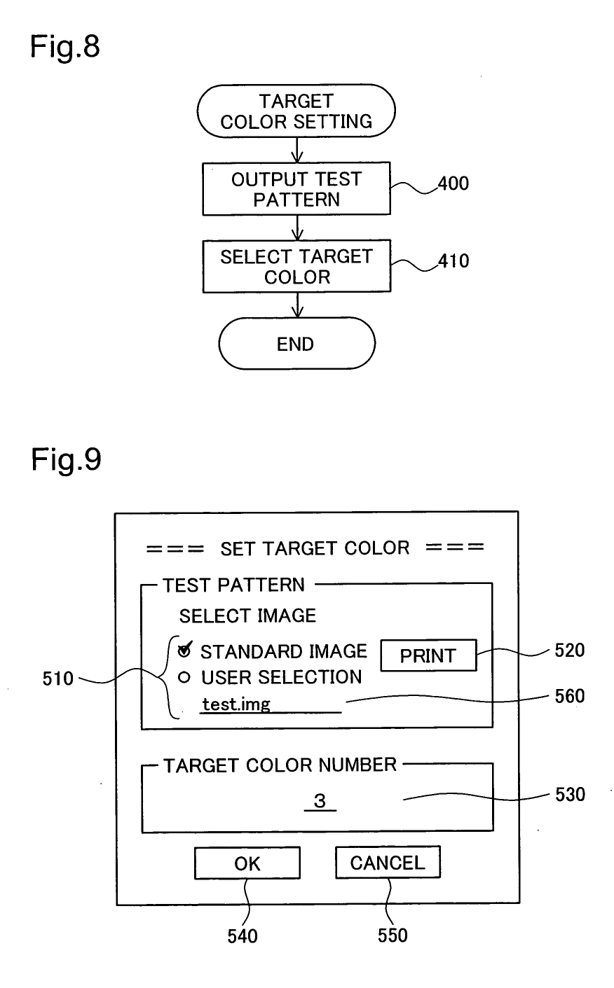

FIG. 8 is a flow chart showing the sequence of operations for the target color setting routine executed by the image data processing program 200 described above (see FIG. 4). In step S400, the test pattern forming unit 250 (see FIG. 4) prepares a test pattern that can be used in setting the target color. After the prepared test pattern is converted into print data PD by the print data generator 220, it is sent to the printer 20. The printer 20 then prints the obtained test pattern. This test pattern will be described in detail below. In step S410, using the test pattern output results, the user determines a desired target color that will enable high-quality output results to be obtained, and sets the target color via the target color setting unit 230. The target color set via the target color setting unit 230 is stored by the target color storage unit 240, and the routine ends.

FIG. 9 is an explanatory drawing showing the target color setting using the image data processing program 200 (see FIG. 4) in the above-described flow chart of FIG. 8. As shown in the drawing, when the user opens the target color setting window of the image data processing program 200, the target color setting unit 230 displays a window on the monitor 21 by which the user sets the target color. The displayed window has a test pattern selection area 510, a test pattern print start button 520, a target color number setting area 530, a setting button 540, and a cancel button 550.

The user can select the type of test pattern to be printed via the test pattern selection area 510. In this embodiment, either ‘Standard image’ or ‘User selection’ can be selected. If ‘Standard image’ is selected, a test pattern is prepared using a preset standard image. If ‘User selection’ is selected, a test pattern is prepared using an original image selected by the user. The user can specify original image data to be used for test pattern preparation by entering into the image data specification area 560 the file name of the image file that stores the image data. When the user presses the test pattern print start button 520, the selected test pattern is printed.

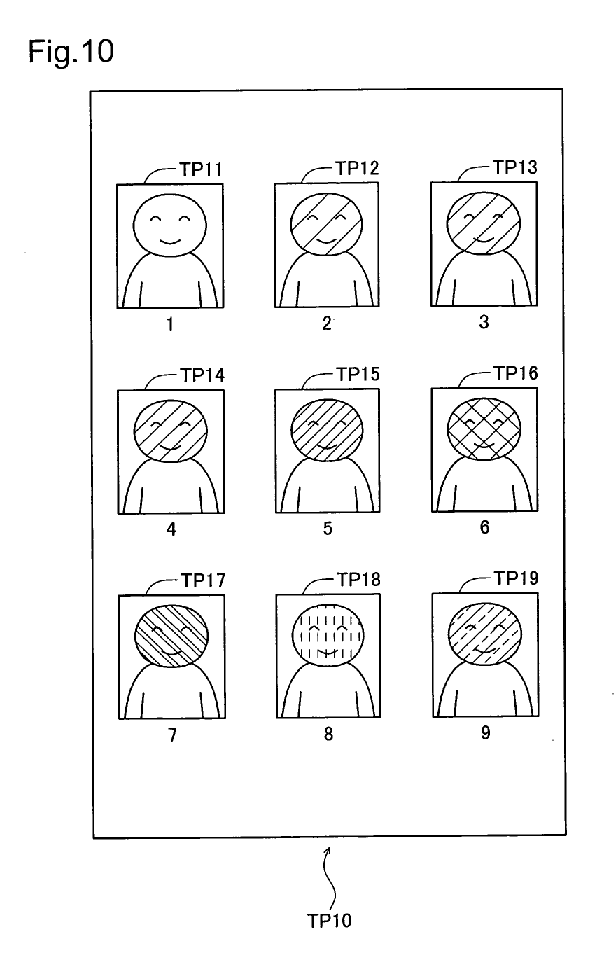

FIG. 10 is an explanatory drawing showing an example of a test pattern where a standard image is used. The standard image includes a memory color area. For example, where image quality adjustment is performed using skin color as the memory color, an image of a person that includes a skin color area is used as the standard image. This test pattern TP10 is composed of multiple images TP11-TP19. In the multiple images TP11-TP19 the same standard image is used, but the memory color area of each image is expressed using a different target color. Therefore, the test pattern TP10 includes multiple images TP11-TP19 that each have a different target color. Here, ‘different target color’ means that at least one of the parameters of hue, saturation and lightness is different. Underneath each of these multiple images is displayed a target color number that identifies the target color reproduced in that image. The user can select a desired target color by selecting the target color number displayed underneath the image among the multiple images TP11-TP19 that reproduces the preferred color.

Where ‘User selection’ is selected in the test pattern selection are 510, a test pattern composed of multiple images using an original image chosen by the user is prepared in the same manner as in the example shown in FIG. 10. This situation differs from the example shown in FIG. 10 in that while the multiple images are images that all use a common user-specified image, they are images that reflect the results of image quality adjustment using mutually differing target colors. The user can select a target color by comparing the results of image quality adjustment using the various different target colors. Because a target color can be selected from output image results following image quality adjustment, a preferred target color can be easily selected. One of the images among the multiple images may be an image for which image quality adjustment was not performed. In this case, because a target color can be selected while comparing images prepared before and after image quality adjustment has been performed, the appropriate target color can be selected while taking into account the amount of image quality adjustment.

The user can set the target color by entering the selected target color number in the target color number setting area 530 (see FIG. 9) and pressing the setting button 540. The target color set via entry in the target color number setting area 530 is stored in the target color storage unit 240 (see FIG. 4) and is used by the image quality adjustment unit 210 at the time of printing. If, on the other hand, a user-specified target color is not stored in the target color storage unit 240, it is preferred that the image quality adjustment unit 210 execute image quality adjustment using a standard general target color set in advance. This way, a high-quality image with improved color can be output even where the user does not set a target color.

All or some of the screen elements displayed in the example shown in FIG. 9 above may be displayed in the operation panel 32 of the printer 20 (see FIG. 3).

As described above, in the first embodiment, because the color of a memory color area can be adjusted using a target color set by the user, high-quality output results can be achieved in accordance with the user's preference. Furthermore, because a test pattern that can be used for setting the target color can be output, the user can easily set the target color to an appealing color using the test pattern.

B3. Second Embodiment of Target Color Setting Routine:

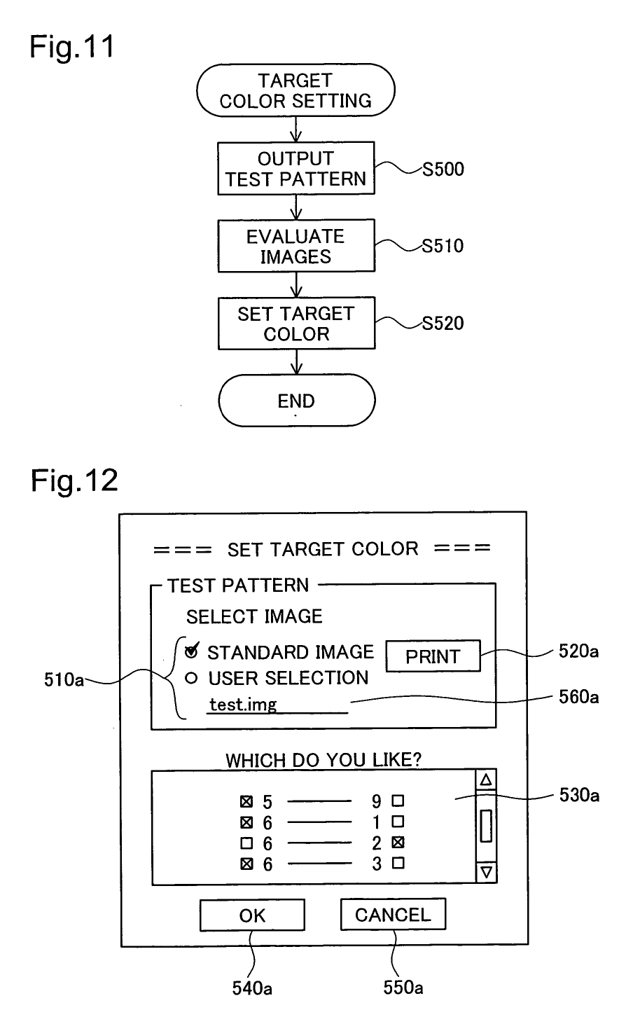

FIG. 11 is a flow chart showing the sequence of operations for a second embodiment of the target color setting routine. The difference between this embodiment and the first embodiment shown in FIG. 8 is that instead of one target color being selected by the user, the target color is set using multiple results of evaluation for multiple images included in the test pattern.

FIG. 12 is an explanatory drawing showing an example of the target color setting window of the second embodiment of the target color setting routine. This window is different from the target color setting window of the first embodiment of the target color setting routine shown in FIG. 9 in that the target color number setting unit 530 is replaced with a preferred evaluation result entry area 530a in which one preferred image is specified with respect to every image pair.

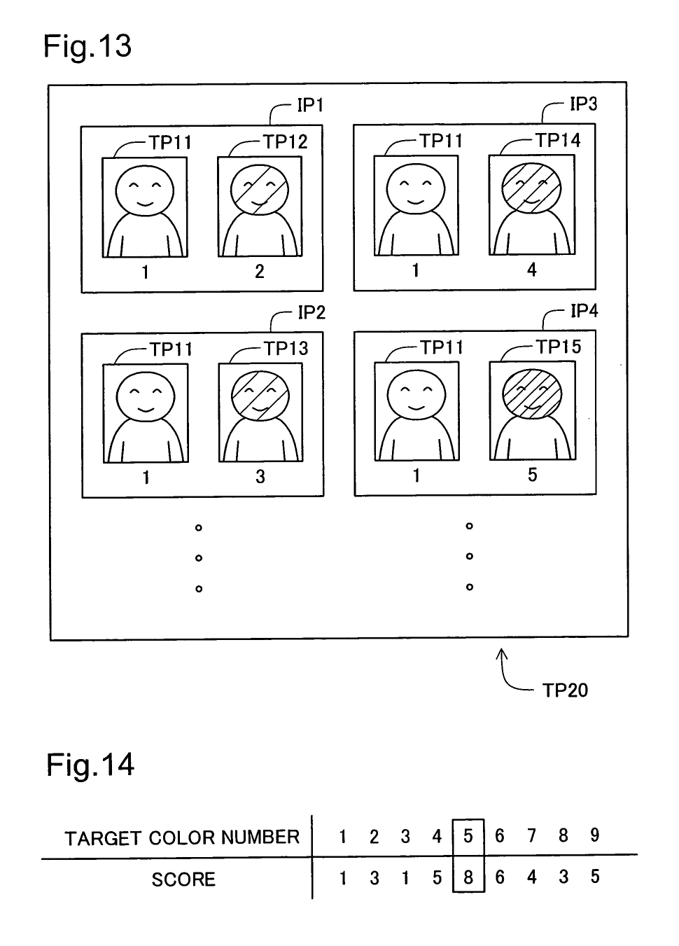

When the user presses the test pattern print start button 520a, the test pattern is printed (step S500 in FIG. 11). FIG. 13 is an explanatory drawing showing one example of a test pattern using a standard image. This test pattern TP20 includes four image pairs IP1-IP4. The images TP11-TP15 that comprise these image pairs IP1-IP4 are the same images that were included in the test pattern shown in FIG. 10. These images TP11-TP15 are images in which areas the color of which is close to that of the memory color (‘memory color areas’, or skin color areas in this example) are reproduced using multiple different target colors (also termed ‘candidate target colors’). Such images are hereinafter referred to as ‘target color images’. ‘Image pair’in this embodiment corresponds to ‘image group’ in the present invention.

The combinations of two target color images comprising an image pair are each different from the other image pairs. The two associated target color images in each pair are arranged in a side-by-side fashion. In addition, a target color number (a number from 1 to 5) that identifies the candidate target color is displayed underneath each target color image.

The test pattern TP20 is prepared such that it includes all of the possible combinations of the images that comprise the nine target color images TP11-TP19 shown in FIG. 10 (36 combinations), although some are omitted from the drawing in the example shown in FIG. 13. For each of the image pairs included in the test pattern TP20, the user can enter the results of comparison of the two images in the preferred evaluation result entry area 530a (see FIG. 12). When the user presses the setting button 540a, the target color setting unit 230 (see FIG. 4) receives the multiple evaluation results entered in the preferred evaluation result entry area 530a (step S510 in FIG. 11).

Next, the target setting unit 230 determines the target color based on a score of the preferred candidate target colors that are obtained through analysis of the multiple received evaluation results (step S520 in FIG. 11). Here, ‘score’ is an index indicating the strength of the user's evaluation, and constitutes a value that increases as the target color's appeal increases. In the second embodiment, the score of the candidate target color is the number of times the associated target color image is evaluated as preferable in comparison with another target color image.

FIG. 14 is an explanatory drawing showing an example of scores. In FIG. 14, the table shows the target color number corresponding to each target color image and the score for each such image. The target color setting unit 230 (see FIG. 4) uses the highest-scoring candidate target color as the target color. In the example of FIG. 14, the candidate target color identified as number 5 is adopted as the target color. The target color determined in this fashion is stored by the target color storage unit 240 (see FIG. 4) and will be used by the image quality adjustment unit 210.

As described above, in the second embodiment of the target color setting routine, because the target color image can be evaluated, i.e., the target color itself can be evaluated, by comparing two images, there is less of a chance that the user will make an erroneous determination due to confusion than would exist if three or more images were evaluated at a time, and accordingly the possibility that the selected target color will deviate from the user's preference can be minimized. Furthermore, because the user can select one image from between two images, evaluation can be performed without difficulty.

In the test pattern TP20 of the second embodiment, because two target color images to be compared are arranged side by side, the user can easily compare the two target color images. Moreover, because each pair of target color images to be compared in the test pattern TP20 is surrounded by a box and is distinguished from other image pairs, each pair of target color images can be easily recognized.

In addition, in the second embodiment, because the target color is determined based on multiple evaluation results, the possibility that the selected target color will deviate significantly from the user's preference can be reduced in comparison with the case in which the target color is determined based on one evaluation result.

The number of candidate target colors is not limited to nine, and a higher or lower number may be used. If the number of candidate target colors is lower, the degree of effort required by the user to determine the target color can be reduced. Conversely, if the number of candidate target colors is higher, the target color can be selected with more precision. The number of candidate target colors preferably ranges from 3 to 15, and more preferably from 5 to 8.

Occasionally, more than one candidate target color may have the highest score. In such a case, the color expressed by the average gradation value of the multiple candidate target colors having the highest score may be deemed the target color. Alternatively, the target color may be determined by performing the routine shown in FIG. 11 once more using only the multiple candidate target colors having the highest score.

B4. Third Embodiment of Target Color Setting Routine:

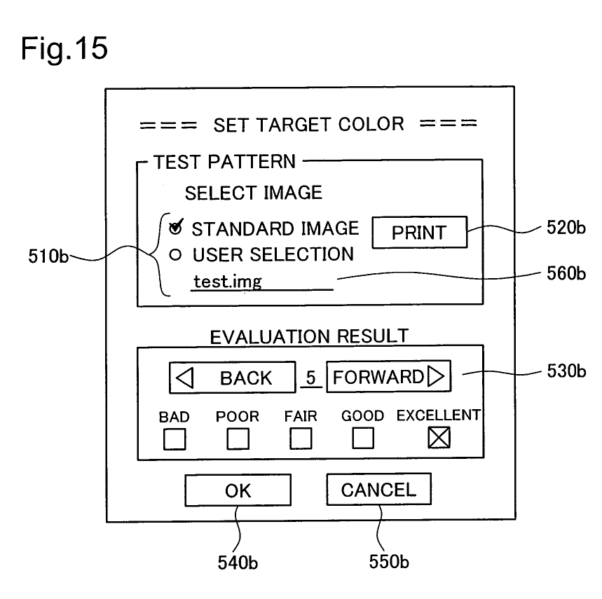

FIG. 15 is an explanatory drawing showing an example of the setting window for a third embodiment of the target color setting routine. This setting window differs from the setting window for the second embodiment of the target color setting routine described above (see FIG. 12) in that a multiple-choice evaluation result entry area 530b is used instead of the preferred evaluation result entry area 530a. Using this multiple-choice evaluation result entry area 530b, the strength of the user's evaluation of each candidate target color can be entered according to the following five levels:

(1) Excellent

(2) Good

(3) Fair

(4) Poor

(5) Bad

The sequence of operations for this target color setting routine is the same as that for the second embodiment (see FIG. 11). The number of the multiple evaluation levels is not limited to five, and more or fewer levels may be used.

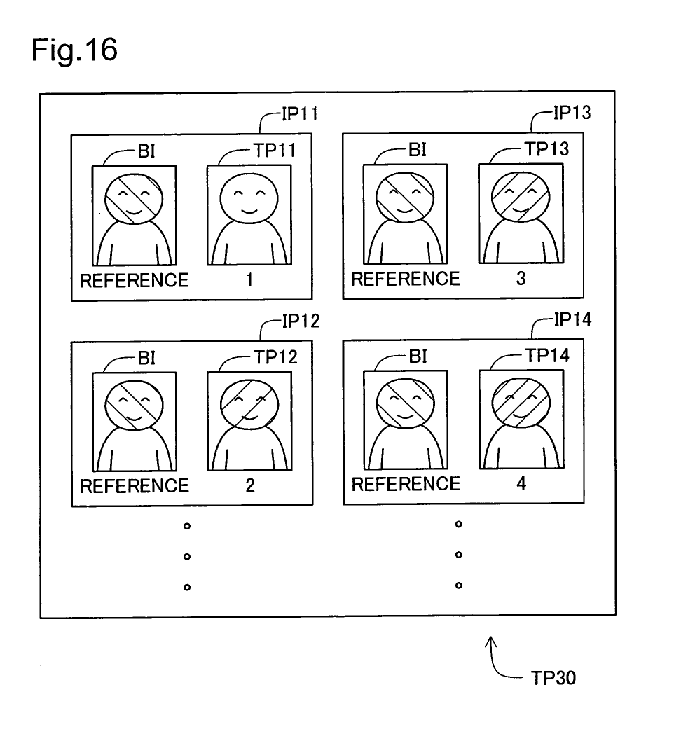

When the user presses the test pattern print start button 520b, the test pattern is printed (step S500 in FIG. 11). FIG. 16 is an explanatory drawing showing an example of a test pattern using a standard image. This test pattern TP 30 includes four image pairs IP11-IP14. These image pairs IP11-IP14 each contain one of the target color images TP11-TP14 and a preset reference image BI that is common to all of the pairs. The reference image BI is an image that uses the same standard image on which the target color images TP11-TP14 are based, and is reproduced using a specific color preset for memory color areas (in this case, skin color areas). Accordingly, the reference image BI can be thought of as a target color image. The test pattern TP30 is prepared such that it includes the nine image pairs each of which contains one of the nine target color images TP11-TP19 shown in FIG. 10, though some are omitted from the example shown in FIG. 16. However, the number of target color images is not limited to nine, and a higher or lower number may be used.

The user can enter the results of evaluation of each target color image in the multiple-choice evaluation result entry area 530b (see FIG. 15) after observation of the test pattern TP30. Here, the user can evaluate each target color image using the common reference image BI included in each image pair as a reference. Therefore, reliable evaluation may be carried out even where a large number of target color images is to be evaluated.

When the user presses the setting button 540b, the target color setting unit 230 (see FIG. 4) receives the multiple evaluation results entered in the multiple-choice evaluation result entry area 530b (step S510 in FIG. 11).

Next, the target color setting unit 230 determines the target color based on the score of each candidate target color as calculated from the multiple received evaluation results (step S520 in FIG. 11). In the third embodiment, the number associated with each evaluation result is used as the score for that target color. Here, ‘Excellent’ is associated with ‘5’, ‘Good’ is associated with ‘4’, ‘Fair’ is associated with ‘3’, ‘Poor’ is associated with ‘2’, and ‘Bad’ is associated with ‘1’. The target color setting unit 230 uses as the target color the candidate target color with the highest score.

As described above, in the third embodiment of the target color setting routine, because the target color image and the reference image are arranged side by side in the test pattern TP30, the user can easily evaluate each target color image based on a comparison with the reference image.

Furthermore, in the setting window shown in FIG. 15, because the strength of evaluation is expressed not in terms of numbers but as words that express an impression received after observation of an image, the user can easily evaluate candidate target color images based on the impressions received following observation of the candidate target color images.

In the test pattern TP30 of the third embodiment, the number of image pairs to be evaluated can be limited to the number of candidate target colors even where the number of candidate target colors is increased. Therefore, an excessive increase in the burden on the user of evaluating target color images (candidate target colors) can be prevented, even where the number of candidate target colors has increased for the purpose of allowing precise setting of the target color. An image specified by the user from among the multiple target color images in the test pattern TP30 can be used as the reference image.

In this embodiment, the test pattern is not limited to the test pattern TP30 that includes image pairs, and in general, any test pattern that includes multiple target colors (such as the test pattern shown in FIG. 10) may be used. Where the test pattern TP30 (see FIG. 16) is used, each image pair IP11-IP14 that consists of two target color images (one of which is a reference image) and that is subject to a single evaluation corresponds to an ‘image group’ in the present invention. Where the test pattern TP10 is used, each target color image TP11-TP19 (see FIG. 10) that is subject to a single evaluation corresponds to an ‘image group’ in the present invention.

B5. Second Embodiment of Image Quality Adjustment Routine:

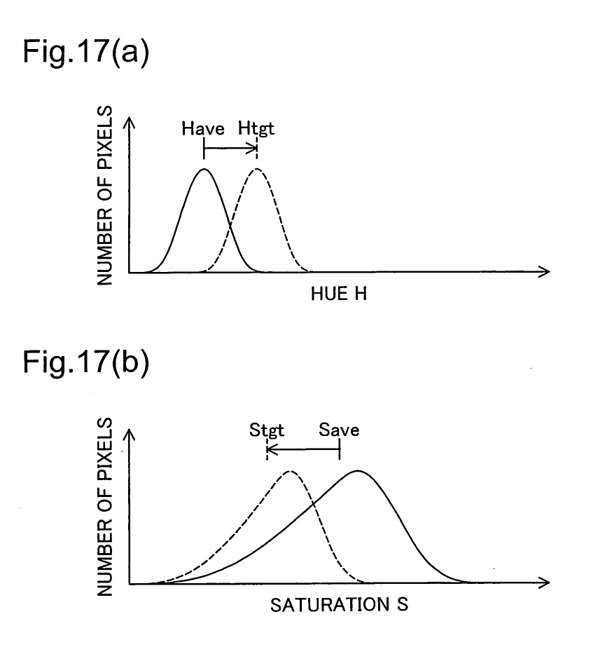

FIGS. 17(a) and 17(b) are explanatory drawings showing the basic aspects of a second embodiment of the image quality adjustment routine (color balance adjustment routine) by which the color of a memory color area is adjusted. This second embodiment differs from the first embodiment shown in FIGS. 7(a) and 7(b) in that the adjustment routine is executed on gradation values for the hue H and saturation S components rather than gradation values for the RGB color components. The sequence of operations for the image quality adjustment routine is the same as that shown in FIG. 5.

First, the image quality adjustment unit 210 (see FIG. 4) analyzes the image data and selects a memory color area (step S300 in FIG. 5). This operation is the same as in the first embodiment of the image quality adjustment routine described above.

Next, the image quality adjustment unit 210 analyzes the pixel values of the memory color area selected in step S300 and calculates the color difference indices representing the difference between the color of the memory color area and the target color. In the second embodiment, the differences in hue H and saturation S are used as the color difference indices instead of the differences in the RGB color components. The color difference index for the hue H is an index that expresses the degree of the difference in hue between the color of the memory color area and the target color, and may consist of the difference between the average gradation value for the hue of the memory color area and the gradation value for the hue of the target color, for example. The color difference index for the hue H calculated in this fashion is used to determine the adjustment amount for the hue H. The color difference index for the saturation S can be calculated in the same manner.

In the next step S320, the image quality adjustment unit 210 determines the amount of adjustment to be carried out during color balance adjustment in order to reduce the color difference index, and in the following step S330, color balance adjustment is performed in order to bring the color of the memory color area closer to the target color.

In the second embodiment of the image quality adjustment routine, the pixel values regarding the hue H and saturation S components for the memory color area are adjusted in accordance with the equations below.

Hnew=Horg+ΔH1 (s10)

ΔH1=Htgt−Have (s11)

Snew=k1*Sorg (s12)

k1=Stgt/Save (s13)

In the equations s10 and s11, Hnew is the hue after adjustment, while Horg is the hue before adjustment. ΔH1 is the amount of hue adjustment, and is derived by subtracting the average hue Have in the memory color area from the hue of the target color (step S310). This value is then used as the adjustment amount in step S320.

FIG. 17(a) is an explanatory drawing showing the distribution of gradation values for the hue H component in the memory color area before and after color balance adjustment. The solid line shows the distribution before adjustment, while the dashed line shows the distribution after adjustment. If color balance adjustment is carried out in this fashion in accordance with the equations s10 and s11, because the average hue in the memory color area comes to equal the hue Htgt of the target color, the color of the memory color area can be brought close to the target color.

At the same time, in the equations s12 and s13, Snew is the saturation component after adjustment and Sorg is the saturation component before adjustment. The value k1 is the amount of saturation adjustment (i.e., an adjustment coefficient) and is derived by dividing the target color saturation Stgt by the average saturation Save in the memory color area. This value is then used as the adjustment coefficient in step S320.

FIG. 17(b) is an explanatory drawing showing the distribution of gradation values for the saturation S component in the memory color area before and after color balance adjustment. The solid line shows the distribution before adjustment, while the dashed line shows the distribution after adjustment. If color balance adjustment is carried out in this fashion in accordance with the equations s12 and s13, because the average saturation distribution value comes to equal the saturation Stgt of the target color, the color of the memory color area can be brought close to the target color.

In the second embodiment of the image quality adjustment routine, because the average values for the hue and saturation components of the color of the memory color area are adjusted so as to approach those of the target color as described above, the color of a memory color area or areas that are easily noticed can be adjusted to a more appealing color.

In the second embodiment of the image quality adjustment routine, adjustment of the gradation value for lightness is not performed. In other words, in this embodiment, the lightness is fixed, and only the hue and saturation are adjusted. Therefore, an extreme change in the lightness of the memory color area resulting in an obviously unnatural color can be prevented. Where the lightness gradation value is not adjusted as described above, it is preferred that the multiple candidate target colors used for test pattern preparation have the same lightness. In this way, the user can easily recognize differences among the multiple candidate target colors.

C. Second Embodiment:

C1. Construction of Image Data Processing Program:

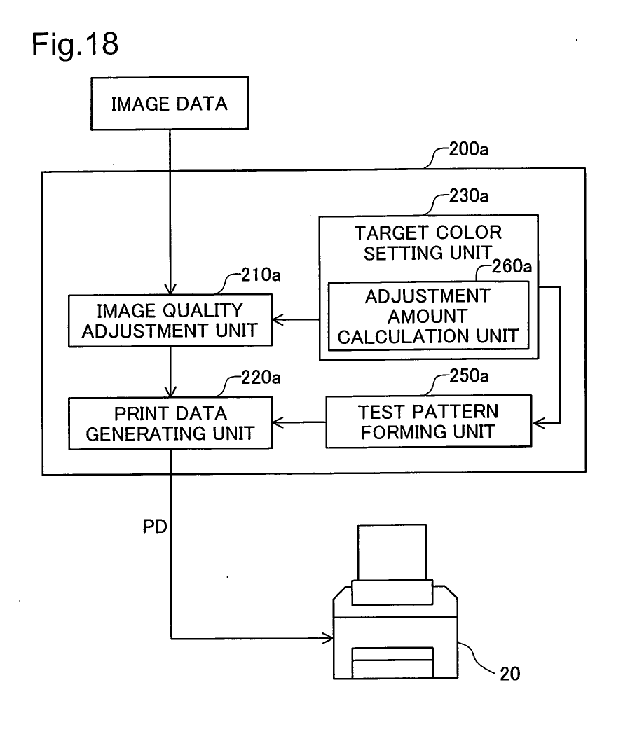

FIG. 18 is a block diagram showing the construction of the image data processing program 200a of a second embodiment. It differs from the image data processing program 200 shown in FIG. 4 in that the target color setting unit 230 includes an adjustment amount calculation unit 260a instead of the target color storage unit 240. The adjustment amount calculation unit 260a determines the adjustment amount for the image quality adjustment routine executed by the image quality adjustment unit 210a based on the score. The construction of the image data processing program 200a is otherwise identical to that of the image data processing program 200 shown in FIG. 4.

C2. Target Color and Score Setting Routine:

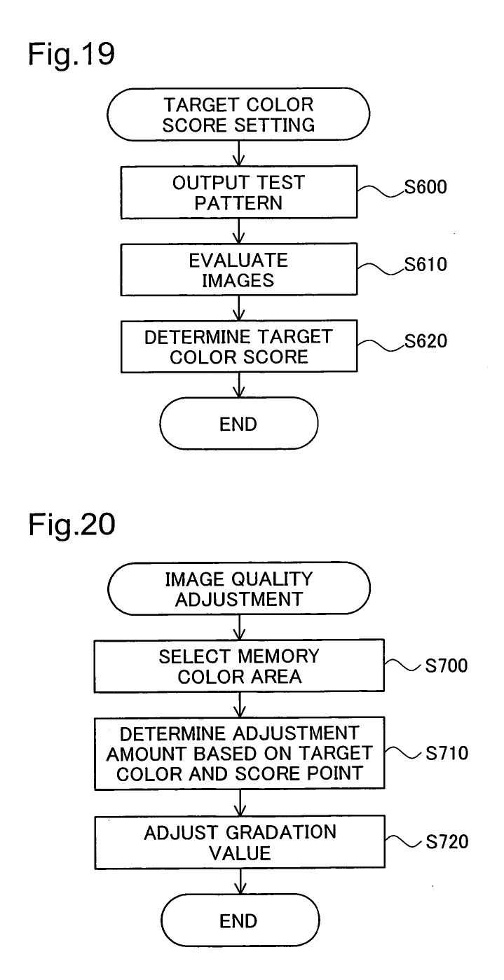

FIG. 19 is a flow chart showing the sequence of operations for the routine by which the target color and the score are determined in the second embodiment. Steps S600 and S610 are identical to the steps S500 and S510, respectively, of the sequence of operations shown in FIG. 11. In steps S600 and S610, the same test pattern and setting screen used in the second embodiment (see FIGS. 12-14) and the third embodiment (see FIGS. 13-15) of the target color setting routine described above can be used.

In step S600, the test pattern prepared by the test pattern forming unit 250a is printed by the printer 20. Specifically, the test pattern forming unit 250a generates test pattern data that represents a test pattern, the print data generating unit 220a converts this test pattern data into print data PD, and the printer 20 prints the test pattern based on the print data PD. It is also acceptable if the test pattern data is stored beforehand on a recording medium (not shown) such as a hard disk drive, and the test pattern forming unit 250a reads the stored test pattern data therefrom.

In step S610, the target color setting unit 230a receives the multiple evaluation results entered from the setting window.

In step S620, the target color setting unit 230a determines the target color based on the scores of the candidate target colors following analysis of the multiple received evaluation results. Here, as in the second and third embodiments of the target color setting routine described above, the candidate target color having the highest score is deemed the target color. The target color and the scores for the candidate target colors are stored by the adjustment amount calculation unit 260a and are used in the image quality adjustment routine described below.

C3. First Embodiment of Score-based Image Quality Adjustment Routine:

FIG. 20 is a flow chart showing the sequence of operations for the image quality adjustment routine (color balance adjustment routine) by which the color of the memory color area is adjusted.

First, the adjustment amount calculation unit 260a selects a memory color area from the image data (step S700). The same memory color area selection method used in step S300 shown in FIG. 5 is used here.

Next, the adjustment amount calculation unit 260a calculates the scores for the target color and for a representative color that represents the memory color area selected in step S700, respectively, and determines the amount of adjustment to be used in the image quality adjustment routine (step S710).

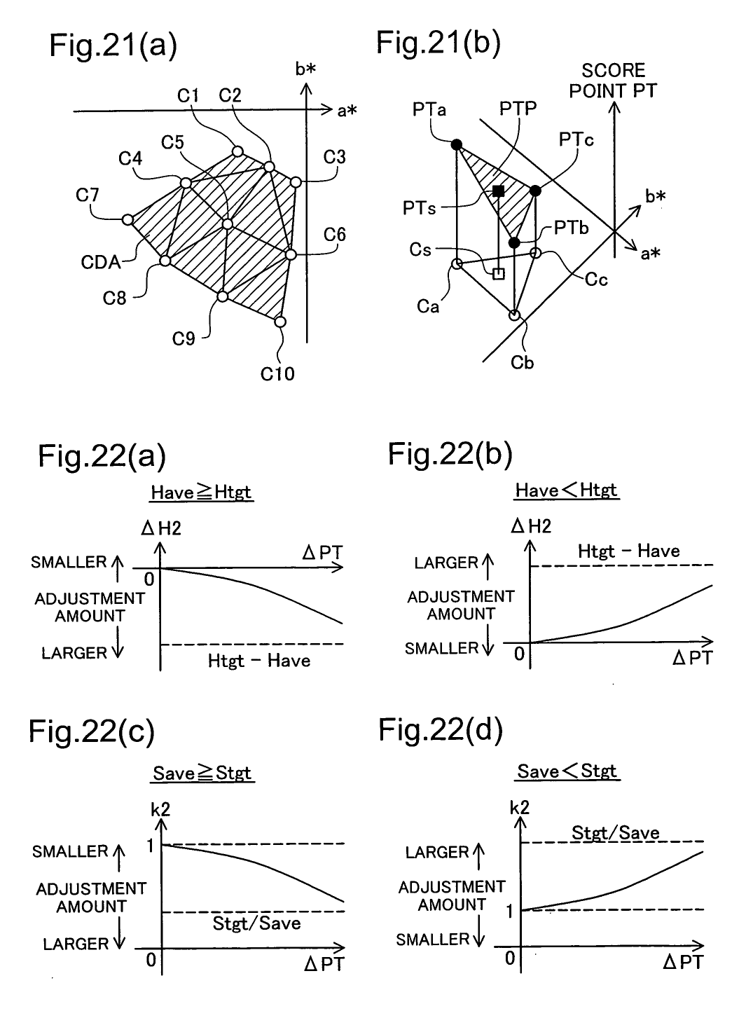

FIGS. 21(a) and 21(b) schematically illustrate the calculation by the adjustment amount calculation unit 260a of a score for the representative color of the memory color area. The representative color of the memory color area means a color that represents the colors in the memory color area within the image data. In this embodiment, the color that is expressed by the average gradation values for hue H and saturation S within the memory color area is used as the representative color. The score for the memory color area representative color means an index that indicates the strength of the user evaluation of the representative color. In this embodiment, this score is calculated via interpolation of the scores for the multiple candidate target colors.

FIG. 21(a) shows a two-dimensional representation of an example of candidate target colors used in point interpolation using a* and b* axes. Here, a* and b* are coordinate values within an L*a*b* color space. Azure is used here as the memory color. In the drawing, the coordinate values expressing the ten candidate target colors C1-C10 (termed ‘candidate target color coordinate points’ below) are shown as open circles.

Incidentally, in the image quality adjustment routine of this embodiment (to be described in detail below), only the hue H and saturation S components are adjusted, as in the second embodiment of the image quality adjustment routine described above (see FIG. 17). Accordingly, colors having the same lightness are used as the multiple candidate target colors. Therefore, the score for each respective candidate target color refers to the strength of the evaluation for the combination of hue and saturation (a* and b* in the L*a*b* color space) for that candidate target color.

In FIG. 21(a), the candidate target color distribution area CDA is shown via diagonal shading. The candidate target color distribution area CDA is the maximum area that can be surrounded by multiple lines that connect a given pair of points among the candidate target color coordinate points C1-C10. The candidate target color distribution area CDA is divided into triangular areas formed with three candidate target color coordinate points as vertices. The adjustment amount calculation unit 260a calculates a score for an arbitrary color within a triangular area by interpolation using the scores assigned to the three candidate target colors that comprise the vertices of that triangular area. The combinations of these three candidate target colors are set beforehand.

FIG. 21(b) is an explanatory drawing that explains score interpolation using the score point space defined by a*, b* and the score point PT. In a two-dimensional space in which the score point is zero, i.e., in a two-dimensional space defined by a* and b*, the three candidate target color coordinate points Ca-Cc are shown as open circles. The representative color coordinate point Cs to be sought from score interpolation is shown as an open square. In the score point space, the coordinate points that express the three score points PTa-PTc are shown as solid circles. These score points PTa-PTc are the respective scores of the three candidate target colors Ca-Cc. The score plane PTP that includes the coordinate points of these three score points PTa-PTc is shown using diagonal shading.

For the score for the representative color Cs, the adjustment amount calculation unit 260a uses the coordinate point on the score point plane PTP that is expressed as the coordinate point PTs at which the a* and b* values are the same as those of the representative color Cs.

Because in this embodiment the score is calculated via linear interpolation of the scores for three candidate target colors, the score for the representative color within the memory color area can be optimized based on the scores for the candidate colors. The method for calculating the score is not limited to linear interpolation, and various other methods for calculating the score based on the scores for the respective candidate target colors can be used. For example, a mathematical function that establishes the relationship between an arbitrary color and its corresponding score may be used where the function is adjusted to permit reproduction of the candidate target colors and their corresponding scores.

Next, the adjustment amount calculation unit 260a determines the amount of adjustment to be carried out in the image quality adjustment routine based on the calculated score. Incidentally, in the first embodiment of the score-based image quality adjustment routine, the hue H and saturation S components are adjusted according to the equations below, as in the second embodiment of the image quality adjustment routine described above (see FIG. 17).

Hnew=Horg+ΔH2 (s20)

Snew=k2*Sorg (s21)

In the equation s20, Hnew is the hue after adjustment, Horg is the hue before adjustment, and ΔH2 is the hue adjustment amount. FIGS. 22(a) and 22(b) are graphs showing the relationship between the adjustment amount ΔH2 of the hue H and the score point difference ΔPT. FIG. 22(a) shows the case where the condition (a1) of ‘Have ≧Htgt’ is valid, while FIG. 22(b) shows the case where the condition (a1) is not valid. Here, the score point difference ΔPT is the difference that results when the score point for the representative color of the memory color area is subtracted from the score point for the target color. The hue value Have is the average gradation value for the hue H of the memory color area, and indicates the hue representing the memory color area. The hue value Htgt indicates the hue of the target color.

When the condition (a1) is valid, because the adjustment amount ΔH2 is set as a negative value as shown in FIG. 22(a), the hue of the memory color area can be brought closer to the target color. Furthermore, adjustment is carried out such that the absolute value of the adjustment amount ΔH2 increases as the score point difference ΔPT increases. As a result, because the amount of change in the hue gradation value, i.e. the amount of color balance adjustment (also referred to as the ‘degree’ of adjustment herein), increases as the evaluation of the representative color of the memory color are decreases relative to the target color, the hue can be brought closer to the hue of the target color. However, the absolute value of the adjustment amount ΔH2 is held to a value smaller than the absolute value of ‘Htgt⁻−Have’. As a result, excessive adjustment of the hue H can be prevented.

Where the condition (a1) is not valid, on the other hand, the adjustment amount ΔH2 is set as shown in FIG. 22(b). In this case, the adjustment amount ΔH2 is set to a positive value.

In the equation s21, Snew is the saturation after adjustment, Sorg is the saturation before adjustment, and k2 is the saturation adjustment amount (adjustment coefficient). FIGS. 22(c) and 22(d) are graphs showing the relationship between the adjustment amount k2 of the saturation S and the score point difference ΔPT. FIG. 22(c) shows the case where the condition (a2) of ‘Save ≧Stgt’ is valid, while FIG. 22(d) shows the case where the condition (a2) is not valid. Here, the saturation Save is the average gradation value for the saturation S of the memory color area, and indicates the saturation representing the memory color area. The saturation Stgt indicates the saturation of the target color.

Where the condition (a2) is valid as shown in FIG. 22(c), because the adjustment amount k2 is set to a value of 1 or less, the saturation of the memory color area can be brought close to that of the target color. The adjustment amount k2 moves away from 1 as the score point difference ΔPT increases. As a result, because the amount of change in the saturation gradation value, i.e. the degree of adjustment, increases as the evaluation of the representative color of the memory color area decreases relative to the target color, the saturation can be brought closer to the saturation of the target color. However, the deviation of the adjustment amount k2 from 1 is held to a value smaller than the absolute value of ‘Stgt/Save’. As a result, excessive adjustment of the saturation S can be prevented.

Where the condition (a2) is not valid, on the other hand, the adjustment amount k2 is set as shown in FIG. 22(d). In this case, the adjustment amount is set to a value of 1 or higher.

Once the amount of adjustment to be performed in the image quality adjustment routine is determined, the image quality adjustment unit 210a (see FIG. 18) executes the image adjustment routine using the set adjustment amount, based on the equations s20 and s21 described above (step S720 in FIG. 20).

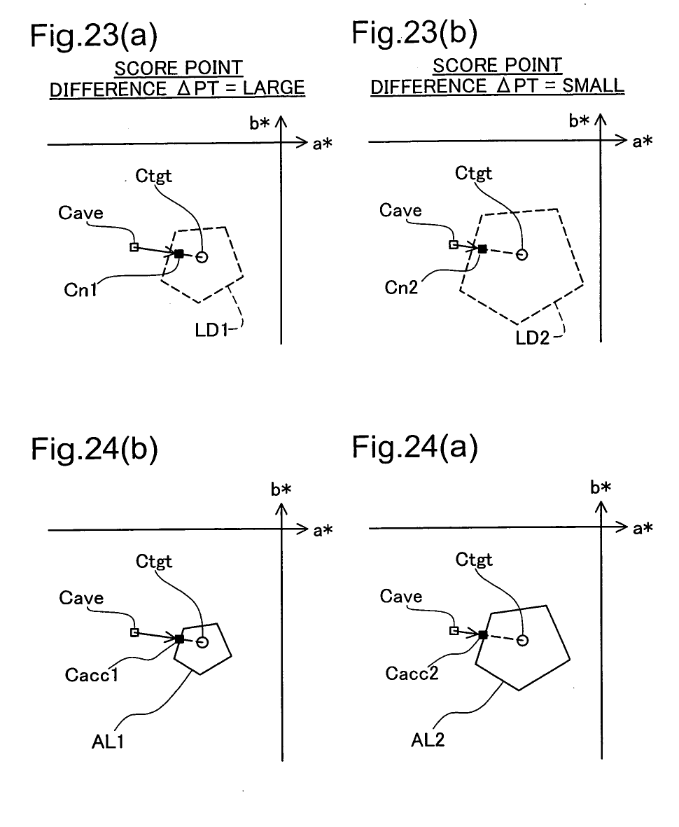

FIGS. 23(a) and 23(b) are explanatory drawings showing the change in the representative color of the memory color area. In FIGS. 23(a) and 23(b), the representative color before and after adjustment is shown in a two-dimensional plane defined by a* and b* (i.e., as coordinate values in the L*a*b* color space). Both drawings show the change in the color where the representative color Cave for the memory color area is brought close to the target color Ctgt. However, FIG. 23(a) shows the case where the score point difference ΔPT is large, while FIG. 23(b) shows the case where the score poitn difference ΔPT is small. Furthermore, in the drawings, the colors Cn1 and Cn2 indicate the representative color of the memory color area after adjustment, and the boundary lines LD1 and LD2 define areas within which the score point difference does not exceed a prescribed value.

Where the color difference is large (see FIG. 23(a)), the adjustment amount becomes large (see FIGS. 22(a)-22(d)), and the representative color can be adjusted to a color Cn1 that is closer to the target color, as described above. As a result, the score (evaluation) for the post-adjustment color Cn1 can be prevented from becoming too low relative to the target color. On the other hand, because the adjustment value becomes small (see FIG. 22) where the score difference is small (see FIG. 23(b)), excessive adjustment of the representative color can be prevented. However, in this case as well, because the score (evaluation) for the post-adjustment color Cn2 is not too low relative to the target color, the color of the memory color area can be adjusted in accordance with the user's preference.

In the first embodiment of the score-based image quality adjustment routine, because the amount of adjustment performed in the image quality adjustment routine is adjusted so that the extent of adjustment performed in the image quality adjustment routine (color balance adjustment routine) decreases as the score for the representative color of the memory color area decreases relative to the target color (i.e., as the score difference increases) as described above, the color of the memory color area can be adjusted in accordance with the user's preference while ensuring that excessive adjustment is not performed.

In the score interpolation routine shown in FIGS. 21(a) and 21(b), the combination of candidate target colors used for score interpolation is not limited to the combination shown in FIG. 21(a), and other combinations may be used. The precision of score calculation can be improved as the color difference index between the candidate target colors and the memory color area used for interpolation decreases.

The coordinate system used for interpolation is not limited to the a* and b* color components, and a coordinate system defined by other color components may be used. For example, a coordinate system defined by hue H and saturation S may be used.

If the representative color of the memory color area were located outside the candidate target color distribution area CDA, the score could be calculated via extrapolation. However, it can be more difficult to obtain adequate precision through extrapolation than through interpolation. Therefore, it is preferred that the candidate target colors be set beforehand such that the candidate target color distribution area CDA includes all possible candidate target colors. For example, the candidate target colors may be set such that the area CDA includes all colors that satisfy the conditions for selection of the memory color area.

The ‘score’ in this embodiment corresponds to the ‘evaluation value’ of the present invention. The ‘target color’ and the ‘score for each candidate target color’ in this embodiment correspond to ‘image quality adjustment parameters’ in the present invention. In addition, where the target color and score are set (see FIG. 19) using the same image evaluation results used in the second embodiment of the target color setting routine described above (see FIGS. 12-14), the target color and score are determined using multiple image evaluation results. Where the image evaluation results used in the third embodiment of the target color setting routine described above (see FIGS. 15 and 16) are used, the target color is determined using multiple image evaluation results.

C4. Second Embodiment of Score-based Image Quality Adjustment Routine:

FIGS. 24(a) and 24(b) are explanatory drawings showing a second embodiment of the score-based image quality adjustment routine. This routine differs from the first embodiment of the score-based image quality adjustment routine shown in FIGS. 22(a)-22(d), 23(a) and 23(b) in that the amount of processing carried out in the image quality adjustment routine (color balance adjustment routine) is determined such that the score for the representative color of the memory color area does not fall below a minimum permissible value. The routine is otherwise identical to the first embodiment of the points-based image quality adjustment routine in regard to its construction and operation.

Various values may be used for this score minimum value, such as:

(1) a preset fixed value;

(2) a preset difference threshold value comprising the difference obtained by subtracting the score for the representative color of the memory color area from the score for the target color; or

(3) a value obtained by multiplying the score for the target color by a prescribed multiplier between one and zero.

In any case, the specific value can be determined based on a sensory test of image output results. Where the evaluation result is entered using the setting screen shown in FIG. 15, the value corresponding to ‘Fair’ may be used as the minimum value.

FIGS. 24(a) and 24(b) are explanatory drawings showing changes in the representative color of the memory color area. In FIGS. 24(a) and 24(b), the representative color before and after adjustment is shown in a two-dimensional plane defined by a* and b* (i.e., as coordinate values in the L*a*b* color space). Both drawings show the change in the color where the representative color Cave of the memory color area is brought close to the target color Ctgt. The boundary lines AL1 and AL2 define areas within which the score does not fall below a minimum permissible value. FIG. 24(a) shows the case where the permissible region that exists between the target color Ctgt and the representative color Cave of the memory color area is small, while FIG. 24(b) conversely shows the case in which the permissible region is large.

The coordinate point Cacc1 shown in FIG. 24(a) represents a color that is on the straight line connecting the representative color Cave of the memory color area and the target color Ctgt as well as on the boundary line AL1 of the permissible region (hereinafter termed ‘permissible color Cacc1’). Similarly, the coordinate point Cacc2 shown in FIG. 24(b) represents the permissible color.

The adjustment calculation unit 260a (see FIG. 18) determines the amount of adjustment performed in the image quality adjustment routine based on the permissible color obtained as described above (step S710 in FIG. 20). Incidentally, in the second embodiment of the points-based image quality adjustment routine, the hue H and saturation S are adjusted based on the following equations:

Hnew=Horg+ΔH3 (s30)

ΔH3=Hacc−Have (s31)

Snew=k3*Sorg(s32)

k3=Sacc/Save (s33)

In the equations s30 and s31, Hnew is the hue after adjustment, Horg is the hue before adjustment and ΔH3 is the hue adjustment amount. Hacc is the hue of the permissible color. In this embodiment, the hue adjustment amount ΔH3 is determined such that the hue of the representative color of the memory color area becomes the hue Hacc of the permissible color, as described above.

In the equations s32 and s33, Snew is the saturation after adjustment, Sorg is the saturation before adjustment, and k3 is the saturation adjustment amount (adjustment coefficient). Sacc is the saturation of the permissible color. In this embodiment, the saturation adjustment amount k3 is determined such that the saturation of the representative color of the memory color area becomes the saturation Sacc of the permissible color, as described above.

Where the score for the representative color of the memory color area equals or exceeds the minimum permissible value, the amount of adjustment regarding the hue H and the saturation S is set to zero, i.e., ΔH3=0 and k3=1.

Once the adjustment amount for the image quality adjustment routine is determined, the image quality adjustment unit 210a (see FIG. 18) executes the image quality adjustment routine based on the equations s30-s33 above, using the previously determined adjustment amount (step S720 in FIG. 20).

In the second embodiment of the points-based image quality adjustment routine, because the amount of adjustment performed in the image quality adjustment routine (color balance adjustment routine) is adjusted such that the score for the representative color of the memory color area becomes the minimum permissible value, the color of the memory color area can be adjusted to a color that accords with the user's preference while excessive adjustment of the color can be prevented.

The present invention is not limited to the embodiments and examples described above, and various other implementations are acceptable within the essential scope of the invention. For example, the variations described below may be used.

D. Variations:

D1. Variation 1:

In the above embodiments, there need not be only one memory color used for color adjustment, and a construction in which image adjustment is carried out for multiple memory colors may be adopted. For example, a construction may be used in which adjustment is performed for human skin color areas, sky blue color areas and mountain green color areas, respectively. In this case, a construction is preferred in which setting of the target color corresponding to each respective memory color is carried out by the user. Such a construction enables high-quality output results to be obtained that better reflect the user's preference. Using this construction, the image quality adjustment unit 210 (see FIG. 4) can perform image quality adjustment in accordance with the various memory colors, the target color storage unit 240 stores multiple target colors corresponding to the respective memory colors, the test pattern forming unit 250 prepares test patterns corresponding to the respective memory colors, and the target color setting unit 230 sets target colors corresponding to the respective memory colors.

D2. Variation 2:

In the above embodiments, it is acceptable if a part of the construction that is implemented by hardware is instead implemented by software, or conversely, if a part of the construction that is implemented by software is instead implemented by hardware. For example, all or part of the functions of the image data processing program 200 shown in FIG. 4 may be executed by the control circuit 40 of the printer 20. In this case, all or part of the functions of the computer 9 that serves as the image data processing device to adjust the image quality of the image data are implemented by the control circuit 40 of the printer 20.

D3. Variation 3:

In the various embodiments described above, a construction may be adopted in which the computer 90 is not used as the image data processing device. In this case, the control circuit 40 of the printer 20 (see FIG. 3) executes the image data processing application program 200 described above (see FIG. 4) in addition to image output processing. The CPU 41 of the control circuit 40 executes image data processing, the RAM 44 temporarily stores calculation results, image data and the like, and the PROM 43 stores data necessary for image data processing, such as the program that performs image adjustment. In other words, the control circuit 40 implements the functions of the image quality adjustment unit and the target color setting unit. Furthermore, the printer 20 has a construction that allows the image data to be obtained without the use of the computer 90. For example, a construction may be used in which a memory card slot 46 (see FIG. 6) that reads the image data stored on the memory card MC is disposed in the printer 90, such that the image data stored on the memory card MC is read thereby. A construction is also possible in which image data is obtained from an image generating device (such as a digital still camera or digital video camera) or a network-connectable dedicated I/F circuit. Using such a construction, printing results that incorporate proper image quality adjustment can be obtained without the use of a computer. In this case, the setting screen shown in FIG. 9 is displayed on the operation panel 32 of the printer 20 (see FIG. 3). The user can set the target color via the operation panel 32.

D4. Variation 4:

The image output device may consist of, besides a printer, a CRT, LCD, projector or television receiver, for example. In any case, high-quality output images in accordance with the user's preference can be obtained through a construction in which color adjustment is carried out using a target color specified by the user. Furthermore, a construction in which a test pattern is output by the output device and the user sets the target color to be used based on output results therefrom, in accordance with the flow chart of FIG. 8, enables a target color to be easily specified by the user. The print data generating unit 220 of the image data processing program 200 (see FIG. 4) converts the image data into data that can be accepted by the output device, rather than into print data. The function to perform this image data conversion need not be incorporated in the image data processing program 200, but may be incorporated into the operating system, for example.

D5. Variation 5:

In the various embodiments described above, the area to undergo image adjustment (i.e., the processing target area) is the same as the area having a color close to the memory color (i.e., the memory color area), but it is not essential that the processing target area and the memory color area match each other. For example, it is acceptable if image adjustment using the target color is carried out for those pixels not belonging to the memory color area but having a hue that is different from the hue of the target color by no more than a prescribed value. In this case, it is preferred that the amount of adjustment in the image quality adjustment routine be set such that it changes continuously from the amount of adjustment for the memory color area to the amount of adjustment for non-processing target areas (i.e., zero) in accordance with the change in the hue. In this way, the border between the area for which image quality adjustment is performed and the area for which image quality adjustment is not performed may be prevented from becoming conspicuous. Here, an adjustment amount obtained using a weighting that decreases as the hue difference from the target color increases can be used as the image quality adjustment amount (such as the adjustment amount RM in FIG. 7).

D6. Variation 6:

In the embodiments described above, the representative color of the memory color area is not limited to the color expressing the average gradation value of the pixels in the memory color area. In general, any color representing the color memory color area may be used. For example, a color having a gradation value that occurs most frequently in the memory color area may be used.

The color difference index representing the color difference between the memory color area and the target color is not limited to the difference between the gradation value of the representative color of the memory color area and the gradation value of the target color. In general, it may be any index that indicates the degree of difference in color. Furthermore, as the color gradation value, the gradation value of any color component expressed in any of various types of color space may be used.

The multiple target color images are not limited to images having various candidate target colors, respectively, and in general may be any image that includes a memory color area wherein the memory color area is reproduced using a candidate target color. For example, an image having a smaller color difference index between the memory color area and the candidate target color associated with the image than the color difference indices between the memory color area and other candidate target colors may be used as the target color image.

D7. Variation 7:

In the above embodiments, target color setting may be performed multiple times in order to reduce the deviation between the target color and the user's preferred color. In this case, if each time target color setting is repeated, the color difference between candidate target colors is made to decrease gradually, and the multiple target colors are replaced with colors derived from the best target color at any given time (hereinafter referred to as ‘provisional target color’), a more suitable target color can be determined. Where this method is applied in the embodiment that uses image pairs that include a reference image (the second embodiment of the target color setting routine; see FIG. 16), the target color image that includes the provisional target color may be used as a new reference image.

D8. Variation 8:

In the various embodiments above, it is preferred that some of the multiple candidate target colors have the same value for at least one of hue, saturation and lightness. If at least one color attribute is identical in this fashion, the user can easily discern between colors when evaluating target color images, enabling images to be evaluated in accordance with the user's preference.

D9. Variation 9:

In the various embodiments above, the test pattern forming units 250 and 250a (see FIGS. 4, 18) can generate image pairs (image groups) using a user-specified image. In other words, the test pattern forming units 250 and 250a correspond to the ‘image group forming unit’ of the present invention. Furthermore, the test pattern forming units 250 and 250a can also prepare image groups using a standard image. When this is done, images stored beforehand on a recording medium such as a hard disk drive (not shown) can be read in. Alternatively, image groups can be generated using a previously prepared standard image.

The test pattern forming units 250 and 250a and the print data generating units 220 and 220a correspond to the ‘image group supply unit’ of the present invention. Here, where each image group is composed of two images, it is preferred that the image group supply unit supply image groups to the image output unit such that two images are output side by side. The function to output two images side by side may reside with the test pattern forming unit 250 or 250a, or the print data generating unit 220 or 220a. Where a standard image is used, the test pattern forming unit 250 or 250a may have the capability of using already-arranged image groups.

D10. Variation 10:

The image adjustment routine is not limited to adjustment of the color of the memory color area, and may generally constitute processing to adjust the image quality of an image. For example, it may constitute processing to adjust sharpness or the lightness gradation value, or some other type of image quality adjustment. Furthermore, in the various embodiments above, a target color setting unit is used as an image quality adjustment parameter determination unit, and it is preferred in general that there is provided an image quality adjustment parameter determination unit that determines image quality adjustment parameters to be used in the image quality adjustment routine executed by the image quality adjustment unit. Here, ‘image quality adjustment parameter’ refers to the amount of image adjustment, the relationship between the gradation values before and after adjustment, the specific numerical value used for adjustment and the like.

For example, it may sometimes occur that adjustment is performed using a tone curve defined by the relationship between an input value and an output value. In this case, the ‘tone curve’ corresponds to the ‘image quality adjustment parameter’ of the present invention. Accordingly, it is preferred that there is provided an image quality adjustment parameter determination unit that determines the tone curve to be used in the image quality adjustment routine. It is preferred that the image quality adjustment parameter determination unit determine the tone curve using multiple results of user evaluation for each image group using images having different tones. The images to be evaluated may consist of images obtained via processing of the same original image using various tone curves set in advance, for example.

The image quality adjustment routine may include in general a process to convert first image data into second image data. For example, where an image is printed using a printer, processing is performed to convert the color data component of the image data to multiple-tone data defining the amount of ink of each color to be used by the printer (termed ‘ink amount set’ below). The relationship between the color data and the ink amount set is stored in the form of a color conversion look-up table (LUT). A color conversion LUT can be prepared such that the color of the memory color area is brought closer to the target color via color conversion processing.

When a color conversion LUT is to be created in consideration of a memory color, a target color is first determined. The method used for determining the target color may be the same method used in the embodiments described above. Next, the relationship between the color data and the ink amount set is defined. Here, the multiple ink amount sets corresponding to the multiple color data for the memory color area are defined such that the values for the ink amount sets approach those that are needed in order to reproduce the target color. Accordingly, the relationship between the color data to be entered and the ink amount set to be output is stored in the color conversion LUT. The color conversion LUTs created this way are installed on the computer as data to be referred to by a color conversion processing program (such as a printer driver) that executes color conversion processing, together with the color conversion processing program itself. The ‘target color’ referred to in this embodiment corresponds to an ‘image adjustment parameter’ in the present invention. Alternatively, it may be considered that the ‘look-up table’ corresponds to an ‘image adjustment parameter’.

D11. Variation 11:

For the images used for evaluation in order to determine the image quality adjustment parameter for a certain image quality, multiple images each having a different certain image quality may be used in general. For example, processed images obtained by performing image quality adjustment regarding a single original image using mutually different image quality adjustment parameters may be used. In this case, it is preferred that an original image specified by the user be used. This enables the image quality characteristics of the image data generated by the image generating device to be reflected in the determination of the image quality adjustment parameters. In addition, if a natural image is used as the image used for evaluation, it can be ensured that the image quality parameter appropriate for image quality adjustment of natural images is obtained. For example, a scenery image that includes the sky can be used for color adjustment of a blue-sky area.

D12. Variation 12:

In the above embodiments, the number of evaluation images constituting a single image group is not limited to one or two, and three or more may be used. For example, it is acceptable if an image group includes three evaluation images and one evaluation image is specified as the evaluation result. In this case, the image quality adjustment parameters may be determined using the same method as that used in the second embodiment of the target color setting routine (see FIGS. 12-14).

D13. Variation 13:

In the various embodiments above in which the color of a memory color area is adjusted, target color setting may be carried out using multiple evaluation results selected by the user for each of multiple different lightness levels. For example, a method may be employed wherein a target color (hereinafter termed the ‘reference target color’) for each of multiple lightness levels set beforehand (hereinafter termed the ‘reference lightness levels’) is determined using evaluation results for each reference lightness level, and the final target color is determined using the multiple reference target colors.

For example, where the construction described in FIG. 4 is used, the test pattern forming unit 250 creates a test pattern for each of multiple reference lightness levels or for each of the reference target colors. When this is done, the multiple target color images included in the test pattern for the single reference lightness level are reproduced with multiple candidate target colors having the same reference lightness level. In other words, the test pattern for one reference lightness level includes only target color images in which the lightness level of the candidate target color is the same as the reference lightness level. Therefore, the user can easily recognize differences in the color of the memory color area when evaluating each reference lightness level.

Where image quality adjustment is performed regarding the same original image to generate target color images, it is preferred that an image quality adjustment routine also includes lightness level adjustment (see the adjustment routine shown in FIG. 7, for example). It is further preferred that an image in which the representative lightness level of the memory color area is the same as the reference lightness level to be used. This will prevent the occurrence of an unnatural difference in lightness between the memory color area and other areas of the target color image. In this case, the original image will be different for each reference lightness level. As the reference lightness levels, L*=70 (bright), L*=55 (medium) and L*=40 (dark) can be used (where L* is the lightness level in the L*a*b* color space).

The target color setting unit 230 receives user-specified evaluation results for each of the multiple reference lightness levels and determines the base target color image using these evaluation results. The method used to determine the base target color from the evaluation results may consist of the method shown in FIGS. 9 and 10, i.e., the method that uses a single evaluation result to specify a target color, or may consist of the method shown in FIGS. 12-14 and FIGS. 15-16, i.e., the method in which multiple evaluation results are entered for multiple image pairs. Where evaluation results for image pairs are used, the multiple image pairs corresponding to a single reference lightness level comprise only target color images for which the lightness level of the candidate target colors equals the reference lightness level.

Next, the target color setting unit 230 determines a final target color using the multiple base target colors. To determine the final target color, a method may be used in which the color expressed by the average gradation value of the multiple reference target colors is adopted as the target color. Furthermore, rather than determining a single target color, the relationship between a lightness level representing a memory color area and a target color may be determined using multiple reference target colors. Here, the relationship between lightness and target color is obtained through linear interpolation from multiple combinations of the reference lightness level and the gradation value of the reference target color. Alternatively, a reference target color corresponding to the reference lightness level having the smallest difference from a given lightness level may be associated with that lightness level. Where a construction in which the target color is adjusted in accordance with the lightness level in this way is used, the target color can be set appropriately in accordance with the lightness level of the memory color area within the image data.

The relationship between lightness and target color obtained in this fashion is stored in the target color storage unit 240. The image quality adjustment unit 210 performs image quality adjustment based on the target color determined based on its relationship to the lightness level of the representative color of the memory color area. When this is done, an image quality adjustment routine that includes adjustment of lightness as shown in FIG. 7 may be carried out, or an image quality adjustment routine that excludes adjustment of lightness as shown in FIG. 17 may be carried out. The ‘reference target color’ referred to in this embodiment corresponds to an ‘image quality adjustment parameter’ in the present invention.

In the construction shown in FIG. 18 as well, target color determination is performed using evaluation results for multiple lightness levels as described above. In this case, the scores for the reference target color and the candidate target colors are determined for each reference lightness level. In addition, the adjustment amount calculation unit 260a can calculate the score for the representative color of the memory color area based on the scores for the candidate target colors determined for each of multiple lightness levels in the same manner as for the target color. In this case, it may be considered that ‘reference target color’ and ‘candidate target color score’ corresponds to ‘image quality adjustment parameters’ in the present embodiment.

D14. Variation 14:

In the above embodiments, a construction may be adopted in which the image quality adjustment parameters are determined for each image scene type used at the time of image data generation. For example, where lightness gradation value adjustment is performed, adjustment that makes the entire image brighter tends to be preferred when the image is a portrait. In the case of a scenery image, adjustment that emphasizes contrast tends to be preferred. Accordingly, if a different tone curve is selected for each type of image scene, such as ‘portrait’ or ‘scenery’, the image lightness level can be properly adjusted in accordance with the image scene type. In this case, the image adjustment parameter determination unit establishes image quality adjustment parameters (in this example, tone curves) for each image scene type, and the image quality adjustment unit selects an image quality adjustment parameter to be used based on the image scene type.

Incidentally, some image generating devices (such as digital still cameras) generate an image data file that stores image data and image scene type information. Image scene type information is information that is entered by the user when an image is captured or shot by the image generating device, and may consist of ‘portrait’, ‘scenery’ or ‘night shot’. Where gradation value adjustment is carried out for lightness using this image data file, an appropriate tone curve can be selected automatically using the image scene type information.

D15. Variation 15:

In the above embodiments, it is preferred that image groups be output using a method in which each image group is output in such a way that it is distinguished from other evaluation images. Various methods may be used here, including a method wherein each image group is surrounded by a square, or a method wherein each multiple image group is printed onto separate pages, for example. Where a device that displays images (such as an LCD display or a projector) is used as the image output device, a method wherein only one image group is displayed at a time may be used. In this case, a routine comprising the step of displaying one image group and the step of receiving an evaluation result for the displayed image group is performed for multiple image groups.

Where the image group consists of two evaluation images, and the evaluation result indicates one image selected from among the two evaluation images (such as in the example shown in FIG. 12), the routine described above may be repeated after replacing the evaluation image that was not selected with a different evaluation image while continuing to display the selected evaluation image. If this routine is repeated for all evaluation images until there is no change in the displayed images, the desired image quality adjustment parameters can be easily determined.

What is claimed is:

1. An output device for outputting an image using image data, comprising:
an image quality adjuster for adjusting color of an area within the image data that is close to a preset memory color such that the color comes closer to a preset target color;
a target color setter for allowing a user to set the target color; and
an image output unit for outputting an image in accordance with the color-adjusted image data.

2. The output device according to claim 1, further comprising a test pattern forming unit for providing a test pattern that can be used during setting of the target color,
wherein the image output unit is capable of outputting the test pattern.

3. The output device according to claim 2, wherein the test pattern includes multiple images that have respective target colors each having a mutually different value for at least one of hue, saturation and lightness components.

4. The output device according to claim 2, wherein the test pattern includes multiple images obtained via image quality adjustment of a single original image using multiple target colors each having a mutually different value for at least one of hue, saturation and lightness components.

5. The output device according to claim 3, wherein the test pattern forming unit provides the test pattern with respect to each of preset reference lightness levels where a lightness level of the target colors used in the test pattern is set to the reference lightness level,
wherein the target color setting unit receives multiple evaluation results determined by the user for the reference lightness levels and determines the target color using the multiple evaluation results.

6. The output device according to claim 3, wherein the images included in the test pattern are natural images.

7. The output device according to claim 4, wherein the test pattern forming unit allows the user to specify the original image.

8. The output device according to claim 1, further comprising an image group supply unit for supplying to the image output unit a plurality of image groups each including at least one target color image from among a plurality of target color images, the plurality of target color images being natural images for evaluation in which the area, the color of which is close to the memory color, is reproduced by using one of preset candidate target colors each having a mutually different value for at least one of hue, saturation and lightness components,
wherein the target color setting unit receives multiple evaluation results determined by the user for each of the plurality of image groups and determines the target color using the multiple evaluation results.

9. The output device according to claim 8, wherein the target color setting unit determines an amount of the color adjustment using the multiple evaluation results separately from determination of the target color.

10. The output device according to claim 9, wherein the target color setting unit is capable of calculating an evaluation value indicating strength of evaluation of color that is close to the memory color using the multiple evaluation results, and increases the amount of color adjustment as a difference increases between the evaluation value for the target color and the evaluation value for a representative color representing the area within the image data the color of which is close to the memory color.

11. The output device according to claim 9, wherein the target color setting unit is capable of calculating an evaluation value indicating strength of evaluation of color that is close to the memory color using the multiple evaluation results, and adjusts the amount of color adjustment such that the evaluation value for a representative color representing the area within the image data the color of which is close to the memory color becomes a value no lower than a prescribed threshold value after the color adjustment.

12. The output device according to claim 8, wherein each of the plurality of image groups consists of two of the target color images, and the image group supply unit supplies the image groups to the image output unit such that the two target color images are output side by side.

13. The output device according to claim 12, wherein the plurality of image groups include a common target color image.

14. The output device according to claim 12, wherein the evaluation result indicates one of the target color images that was selected by the user.

15. The output device according to claim 8, wherein the target color images included in the image groups are images obtained by carrying out the color adjustment on a single original image using the respective multiple candidate target colors.

16. The output device according to claim 8, wherein the multiple candidate target colors include a plurality of candidate target colors for each lightness level among preset multiple reference lightness levels, the plurality of candidate target colors for each lightness reference level having the reference lightness level,
and wherein the image group supply unit supplies the plurality of image groups each consisting of target color images whose candidate target colors have a same lightness level from among the preset multiple lightness levels.

17. An output method for outputting an image using image data, comprising the steps of:
outputting a screen for allowing a user to set a target color to be used for image quality adjustment of image data;
adjusting color of an area within the image data the color of which is close to a preset memory color such that the color comes closer to the set target color; and
outputting an image in accordance with the color-adjusted image data.

18. An image data processing device for adjusting image quality of image data, comprising;
an image quality adjustment unit for adjusting color of an area within the image data the color of which is close to a preset memory color such that the color comes closer to a preset target color; and
a target color setting unit for allowing a user to set the target color.

19. A computer program for causing a computer to execute image data processing to adjust image quality of image data, the computer program causing the computer to implement the functions of:
outputting a screen for allowing a user to set a target color to be used for image quality adjustment of image data; and
adjusting color of an area within the image data the color of which is close to a preset memory color such that the color comes closer to the set target color.

20. A computer-readable recording medium on which is recorded the computer program according to claim 19.

21. A method for determining an image quality adjustment condition for adjusting image quality of a subject image, comprising the steps of:
(a) outputting a plurality of image groups that include mutually different images, each of the plurality of image groups including at least one image selected from among multiple natural images used for evaluation, the multiple natural images being different from each other in certain image quality;
(b) receiving multiple results of evaluation determined by a user for the plurality of image groups; and
(c) determining the image quality adjustment condition for the certain image quality using the multiple evaluation results.

22. The image quality adjustment condition determination method according to claim 21, wherein each of the plurality of image groups consists of two of the natural images to be evaluated, and the two natural images to be evaluated are output side by side in the step (a).

23. The image quality adjustment condition determination method according to claim 21, wherein the plurality of image groups include a common natural image for evaluation.

24. The image quality adjustment condition determination method according to claim 22, wherein the evaluation result indicates one target color image selected by the user.

25. The image quality adjustment condition determination method according to claim 21, wherein the natural images for evaluation included in the image groups are images obtained by carrying out color adjustment to a single original image using multiple image quality adjustment conditions prepared in advance.

26. The image quality adjustment condition determination method according to claim 25, further comprising the steps of:
(d) receiving a user instruction to specify the original image; and
(e) generating the image groups using the original image specified via the user instruction.

27. A computer program for causing a computer including an image output unit to determine an image quality adjustment condition for adjusting image quality of a subject image, the program causing the computer to implement the functions of:
(a) outputting a plurality of image groups that include mutually different images, each of the plurality of image groups including at least one image selected from among multiple natural images used for evaluation, the multiple natural images being different from each other in certain image quality;
(b) receiving multiple results of evaluation determined by a user for the plurality of image groups; and
(c) determining the image quality adjustment condition for the certain image quality using the multiple evaluation results.

28. A determination device for determines an image adjustment condition for adjustment of image quality of a subject image, comprising:
an image output unit;
an image group supply unit for supplying to the image output unit a plurality of image groups that include mutually different images, each of the plurality of image groups including at least one image selected from among multiple natural images used for evaluation, the multiple natural images being different from each other in certain image quality; and
an image adjustment condition determination unit for receiving multiple results of evaluation determined by a user for the plurality of image groups, and determining the image quality adjustment condition for the certain image quality using the multiple evaluation results.

29. The determination device according to claim 28, wherein the natural images for evaluation included in the image groups are images obtained by carrying out color adjustment to a single original image using multiple image quality adjustment conditions prepared in advance,
the image group supply unit includes an image group generating unit for generating the plurality of image groups using the original image, and
the image group generating unit allows the user to specify the original image.

30. An image processing device for adjusting image quality of a subject image, comprising:
a determination device according to claim 28; and
an image quality adjustment unit for adjusting image quality of the subject image based on the image quality adjustment condition determined by the image quality adjustment condition determination unit included in the determination device.
